(19) United States
(12) Patent Application Publication
(10) Pub. No.: US 2011/0079166 A1
(43) Pub. Date: Apr. 7, 2011

(54) Multi-modal transportation system for solar electric vehicle

(76) Inventor: Liviu Popa-Simil, Los Alamos, NM (US)

(21) Appl. No.: 12/455,442

(22) Filed: Jun. 2, 2009

Related U.S. Application Data
(60) Provisional application No. 61/211,556, filed on Mar. 31, 2009.

(51) Int. Cl. B60L 13/00; B61D 3/00; B60L 11/00; B60L 8/00; B61D 15/06; B61D 47/00; B61D 17/00

(52) U.S. Cl. 105/1.4; 105/49; 180/65.1; 180/2.2

(57) ABSTRACT

A useful system for our transportation needs must be in concert with the ecological and economical needs of the future.

The vehicle concept considers all the constrains imposed by battery materials, oil and electric energy availability and production capacity, electric grid power capability and will make transportation cheaper faster and more robust than the current system.

The multi-feature vehicle is modular in design separating and placing optimally the functional modules so that many variations are easily possible allowing the range, carrying capacity and multi-modal transportation to be optimized. The multi modal transportation feature is a surrogate for the lack of battery capacity to cover the individual needs for transportation avoiding the need for large capital cost for large batteries and their maintenance. The vehicle may serve as backup power source during blackouts and uses own modular compactable solar energy harvesting devices.

The intent of this proposal is to demonstrate the viability of this multi-modal concept and develop the necessary hardware and software to become market ready.

### CROSS REFERENCE TO RELATED APPLICATIONS

This application claims the benefit of no U.S. Provisional Application 61/211,556 incorporated by reference in this entity.

### BACKGROUND

No matter the price fluctuations; declarations of the oil producers, the time of gas-fueled vehicles is going to end. In less than 30 years gasoline will become a very scarce resource. The actual electric cars, following the actual cars concepts requires a lot of batteries, becoming heavy and expensive.

The electric vehicle becomes a strong candidate to replace the thermal engine powered vehicles, but statistic data shows a big shortage ahead in battery materials, available electric power and grid robustness, affordability of the real cost, the daily range:

The Battery Materials:

The World Lithium production is of 21.4 kt/y, while the world's reserves are of about 6.2 Mt. The Ni production is of 134 kt/y, and lead is of the 3.77 Mt/y.

A Advanced Electric Vehicle has 53 kWh, for about 200 miles autonomy transporting a weight of 1¼ tons. The 53 kWh batteries weight 450 kg and may take more than 0.1 t of Lithium to be produced. Similar capacity batteries may use about 0.15 t of Ni, or 0.4 t of Lead.

If the world production will be entirely diverted for electric cars it will be possible to produce 214 k vehicles with Li-Ion battery, 900 k with Ni, and 9425 with lead giving a total of 10.5 M vehicles/year from a total of 60 M annually produced. The total Lithium reserves of 6.2-13.4 Mt will allow less than 14M vehicles to be powered, at all.

There are believes that alternative battery strategy as ZnAir and NaNiCl are not resources constrained, but their fundaments are weak.

The Electric Power Production

There were 254M vehicles registered in 2007 in US only, traveling in average 12,000 miles/vehicle per year. If 50 kWh will deliver 200 miles, that means 3 MWh will be consumed in average per vehicle at 90% efficiency, driving to 760 TWh/year, while the entire US power production was of about 4,157 TWh/(year 2007). That will require an increase by 20% of the power generation, over the average growth of 2.x %. That calculation was optimistic and included the supposition that no battery material constrains would occur.

Scaling this to Earth level, that with a population of about 6 Billions, 20× bigger than US that needs to be transported too, and introducing the climate change challenge that will bring a loss of 2% US-GDP/(year 2015), growing to 3% by 2024 . . . , etc. one can get the magnitude of the problem at planetary level.

The hard outcome of this is that the transportation to be successful and to assure the economic needs and afford the Global Climate Change challenges has to drastically change.

Batteries as Electricity Storage Related Issues

In a superficial view over the electric vehicle this looks ecological, but it simply moves the pollution from the car exhaust pipe to the electricity producing plant and to the battery production chains.

For the moment these are China, Chile and Argentina. In the future that spells “trouble” because US is not well placed at any of the classical battery materials and the dependence of foreign oil will be transformed in dependences of foreign battery materials.

More, the US electric plants use a conversion efficiency of about 25%-30%, not far from the effective efficiency of the actual vehicles. The only difference will be the change of the composition of pure oil exhaust with the palette of US electricity production (more coal, that's worse than oil, with some nuclear, hydro and renewable, that we believe is good).

Another simple calculation shows that if any vehicle will be equipped with a 50 kWh batteries-bank, and leaks 1%/day in average, from its initial charge, by residual discharge process the total capacity for a single loading per year equals: 250 Million vehicles×50 kWh/vehicle=12.5 TWh (3 times the total US electric production from 2007).

To maintain a battery in shape ready to use but not using it, every 3-4 month recharge is needed, which equals 10 times US 2007 electricity production.

This turns to be far worse than gasoline propulsion.

The Grid Robustness

The Advanced Electric Vehicle and EV vehicle advertisement says that to recharge it is enough to plug in and in 45 min. is charged. Now for 50+kWh in 45 min. is necessary an installed power of 100 kW, and one might use a cable by 5 times thicker than that from the dryer. Usual residences have an installed power of 20 kW, in average.

A block transformer usually has less than 200 kW.

Suppose the house e-car powering is solved, but more than two cars will overload the block transformer, and a blackout might be generated. As a factor of demand the US infrastructure and grid would need to be developed by a factor of 10.

This is a huge collateral investment or a drastically reduction of the battery capacity from 50 kWh to less than 5 kWh, and to allow that some other forms of electric energy to be delivered by infrastructure to power the transportation.

The Real Cost Affordability

Usual consumers are looking to the equivalence between the consumption of electricity and gasoline and their cost ratio. Advanced Electric Vehicle a top of its kind takes about 50 kWh for 200 miles, while an equivalent gasoline vehicle makes for about 8 Gallons of regular gas. It seems by about 5 times cheaper to run electrical vehicle.

In reality the classic vehicle needs lubricants, while the electric vehicle needs batteries. A good set of batteries take about 5000 recharging cycles, for a mileage of 1 million miles, at a cost of $50 k. A more accurate specific cost becomes cost of ¼ kWh+5-cent cost of battery per mile, plus some interest giving a cost equivalent of 1 kWh/mile. About the same as with gasoline.

It is also proven that fast charging is reducing the battery life up to 5 times, and the equivalent cost will become higher than 2 kWh/mile (about 25 mpg equivalent). About the same, or a little bit more than the gasoline powered car. No ecologic progress, but pollution redistribution.

Daily Range Bottleneck

The “Advanced Electric Vehicle” may be considered a 90% of the technologic limit, that means about ¼ kWh for 1 ton-mile. The aerodynamic coefficient is as good as possible; the mass is as low as possible, not to much room for improvements here.

### THE STATE OF THE ART

There are 5000 years of experience with the wheel usage, and more than 150 years of automobile developments and patenting. All the ideas used in this approach appeared as separate ideas in various patents and applications before.

The last most advanced developments presenting an interesting idea will be mentioned here from thousands of patents covering the automotive industry.

There are solutions using light vehicles on bicycle wheels since 1883 from the Daimler Benz first patent to the actual Daimler Benz 2009 fuel cell-powered prototype.

The “Go-Boy” multi-seat bicycle like vehicle for leisure and utility purposes are recently made following a car structure—rigid chassis carrying the payload and wheel suspension, that presents some propulsion issues.

The GM-2009 ultra-aerodynamic unmanned vehicle speed structure looks good, reaches a lower than 0.2 Cdx but need a space for payload too.

Carver 2009 develops the tilting tricycle vehicle bringing more stability and acceptable lateral acceleration in passengers and driver—but only the cabin tilts with the first steering wheel. That is the best that concept may deliver, being no real need to tilt the engine.

The recent Brudelli P-mp3-500 is a motorcycle developed in an inverse carver structure with wheels and body tilting. Higher stability and comfort are achieved but the motor remained in the main body.

The RAV industry developed a vehicle secondary under-car or rear mobile garage, starting a multi-modal agreement transport structure.

The 2009 GM 2 wheeler conceived as New York City transport vehicle developed by with verticality assistance system is working at low speeds and is stabilization system critical.

The University Of San Francisco developed a battery recharging station, solar powered that may recharge an electric vehicle in few hours while parked under the solar shed.

The electric bike, scooter, motorbike are already in fashion, giving up to 40 mph speed exhibiting power shortages on slopes.

The electric car is capable of higher acceleration than classical vehicles due to the higher low speed torque of the electric motor.

The 2009 Aprilia Magnet brings an enhanced version of electric motor wheel.

Lumeneo Smera designs a small 1-person vehicle for individual transportation that matches the case of an average 1.3 passengers per car in 2007 US.

Mercedes Benz presents the 3628, a tilting 1-person vehicle.

Honda for 2009 designs the Hermes Carver, a magnet wheel tricycle and an electric town tricycle scooter.

The Mono-mobile 2007 idea of using a mono-rail vehicle to obtain higher mileage and transportation comfort shows an electric vehicle with the batteries, that count for 40% of the vehicle's weight integrated in the structure.

The multi-modal concepts are in full development showing its advantages by the ROR (Rail and Road) developments. This is an old transport style, illustrated by the western movies about the cowboys traveling style. It was a kind of Multi-modal procedure. They took the horse with them in the train, sometimes in different compartments, and from the train destination station to their end of travel destination they made it on horseback.

Several new concepts are available in present, but none fit on the future transportation requirements:
one is fly and drive—that is based on the actual vehicles but its objective function is to save time, and another is
“city-go” with fix location car rental system, and foldable short mileage cars, where the user may not own but use them, with the disadvantage of the distance between users location and assigned parking spot.
   Several things are clear about the electric vehicle:
too big for a single driver 90% of time payload—by 4 times
it has the battery too heavy and central placed to be replaced or recharged in less than 1 h
it is an entirely tire based transportation
it is too expensive and unreliable with sophisticated highly educated maintenance that the society will not enjoy possessing individually.

The present invention brings several concepts are that makes possible to further increase the efficiency of the transportation act, based on in-depth analysis of the dominant functions.

The “street curve” says that the power or energy required for a transportation act is determined by the transported mass, its cross section, aerodynamic coefficient and speed. In spite this is a known fact for over 100 years very few thought to an in depth optimization to consider:
transported mass have to be higher than the payload mass,
aerodynamic coefficient is usually 0.4 but not smaller than 0.2.
cross section has to be bigger than the payload's, and
speed can be reduced but creates discomfort.
   That means that some optimization is possible but the “objective function” is very complex and have to become as reasonable as possible in order to obtain a real macroeconomic relief.

The new car and concept developed is based on a the following directive lines:
Light car customized after the payload—with the mass as small as possible, and the cross section reduced to the minimal comfort and safety dimensions. A human payload, in taxido with its take-on airplane luggage requires a 2 m² cross-section, a 2.4 m length and a 1.2×1.2 m with-height dimensions (18 sqft; L×W×H=8×4×4 ft).
Making the car light is not the only objective—we are optimizing for 3 parameters at this stage, that says—be reasonably light, build with as cheap materials as possible to be safe and ecologically friendly. (Advanced Electric Vehicle is as light as possible but is not cheap or environmentally friendly—as constructive parts are hardly recyclable).
   The specific consumption analysis based on realities shown in FIG. 19 that refers of the single passenger equivalent energy consumption using various transport modes:
      on tires for this payload with specific power train attachments is between 0.1-0.05 kWh/mile for about ¼ ton payload (lower than Advanced Electric Vehicle divided by 4)
      On rail it may become as low as 0.01 kWh/mile. (5 times lower than on tires)
   The market demands as a reflection of the society needs regarding the ownership, usage and maintenance of the new vehicles, where the private persons trend to minimize the investment in transportation vehicles.

The new car concept has only a cockpit privately owned, as main embodiment of the invention, while the communities or federal organizations is taking the burden of very qualified maintenance and may own the propulsion devices. The individual rents them. That makes possible that the capacity of the power train on tires to be customized at the needed range, and terrain specificity. No more batteries added than usually needed plus a power reserve (solar harvesting, efficient gas generator, etc.)

The main original elements of the present invention is that it separates the car mono-block structure in functional modules:
batteries and propulsion;
connection system,
cockpit with life support system and universal coupling devices,
power harvesting system,
auxiliary functions (amphibious, underwater, flying) adaptors.

Another very important embodiment of the present invention is the fact that cockpit has no autonomous propulsion capabilities, but will possess standardized capabilities of connecting to propulsion systems as:

electric vehicle power train,
mono-rail,
rail,
multi-modal ROR (rail or road, with ferry transport capability),
cable, pull-band, Funicular, in road cable propulsion,
UAV flying platforms, Helicopter,
Amphibious and in special cases under-water.

The electric motors power will help it climb 30° slopes with low speed, but will have capabilities of boosting by in-road embedded cable traction.

There are many other features described in the patent but one important is that the battery pack is easy to exchange—being low and lateral outside the vehicle, easy to extract and change with charged ones, without the need to apply life shortening grid demanding fast recharging procedures. A normal charging duration is between 4 to 10 h, which applies a more uniform charge to grid.

Another important embodiment of the present invention is the home backup by the car's battery that requires that the house system to be compatible with car's backup capability and smart enough to separate the power source, in order to maintain the life support functions mainly. This includes a kit for house power connection to car battery backup and house power management during backup.

The Gradual market approach is another embedded feature of the invention. If the acquisition of an electric vehicle requires house power system adaptation, and electric infrastructure, the investment in this solar-electric vehicle requires no special investments—it starts as a neighborhood vehicle, with 40 miles range covered by 2-8 kWh batteries. It recharges alone from its solar panels in 1-2 sunny days if not used. It may be recharged from home grid, and backup it at need.

The vehicle according the US patent is attractive because it has the lifetime greater than 4 years, possible of being delivered at a low price. It has a ROI (return of investment of about 1 year for a gasoline price of $4/Gallon, and 2 years for a gasoline price of $2.50/Gallon, bringing an income by cost avoiding of between $4-12 k in 4 years. In this conditions will be attractive to be bought by individuals. Once on the market the multi-modal developments will become attractive to communities but they have to be ready to implement.

The new multi-modal transportation will require no dedicated or drastically enforced energy grid development while the classic mono-block car concept with no multi-modal requires the doubling of the capacity to mitigate the fluctuation in demand.

The above mentioned originality points are designed to transport 10 times more people than actual electric vehicle with the same battery capacity and the multi-modal propulsion developments aim to minimize the total ecologic impact by making 90% of the transport process to become directly grid powered, preventing excessive battery needs. It will require a combined effort from manufactures and communities to have such efficient system implemented.

For example a high-speed magnetic levitation 2 ways monorail structure using direct grid power may cost only $1 M/mile, with lower environmental fingerprint transporting about 10 k people at 200 miles in one hour, reaching a door-to-door time of 2 hours in a 250 miles range. Actually only helicopter transportation systems can reach this for very few with 20× higher consumption than by a regular car. Compared to this the proposed system will be 1000 times cheaper.

The performances of various multi-modal transportation systems are presented in FIG. 19 with respect to the specific energy consumption per standard passenger (200 lb) and speed of the mode, showing by diamonds the actual performances, and by ellipsoids the present invention expected performances at a payload per total mass ratio of 50%.

The actual market offers a large palette of vehicles mainly derivate from the actual car structures. Almost all suffer from the payload to vehicle mass ratio, and vehicle surface that impacts the autonomy or the mass of batteries.

Compared to that the present approach is looking for ways to minimize the mass, the cross-section and to improve the aerodynamic coefficient. The result is a vehicle for individual transport based on electric propulsion with good autonomy and solar harvesting features.

The actual invention is proposing a multi-feature modular solar-electric vehicle system that may revolutionize the transportation. Starting from a new vehicle concept that separates the functional systems and make them modular, accessible, and interchangeable producing a large diversity of customized transportation systems, optimally fit to meet the needs and requirements of individual and society.

It starts smooth and small, at the low end of the market as a cheap neighborhood vehicle, good for reaching a 40 miles range, with solar harvesting system, possessed by people to perform inside community transport optimization, meant to reduce the costs. The community gradually will build routes for multi-modal vehicles, and own batteries and structures to be fit upon request on any trans-boarding vehicle. The states and federal organization will further develop multi-modal fast structures in order to assure the minimum time and cost travel.

The mass production of this system will prevent the battery material crisis, energy peaking, followed by dramatic transport cost increase with backfiring on life standards, and robustness of the nation. As it was shown before the actual electric vehicle (EV) development is unsafe, driving to potential high economic perturbations with large consequences. The novel system prevents this crisis to happen assuring a smooth development, a continuous growth in transport efficiency and energy harvesting, and gradual development of the multi-modal infrastructure. In the last development stage this system will be preferred even to high-speed high performance transportation mean, for its higher effective commercial speed that none on road autonomous vehicle can reach.

The system according the invention strengthens the infrastructure robustness for transportation purposes It will be accepted easily at the low end as an efficient transport system, with nice features, and developed by community and proving its performances.

The modularity and multi-modality allows accessing various propulsion modes with an equivalent of about two persons showed in FIG. 19, where a transport-action may have up to 10 propulsion components. In FIG. 19 various actual passenger transport means are represented by diamond points in (mileage; speed) coordinates in double logarithmic scale, correlating the transportation mode with speed and cost of energy. The domains of performances where the actual multi-modal vehicle may be are shown by ellipses, for the new vehicle carrying one passenger. This is why the predicted mileage is smaller by a factor of 2 from the actual mileage of the transportation mode analyzed. The new customized optimization equations of transport may be cost oriented, time oriented, energy oriented, and modeled with regards to safety and availability. One may observe that rail propulsion saves important energy and time having low environment impact and shows robustness to nature-elements aggression.

The invention may assure transportation for all 300+ millions of US citizens, avoiding battery materials peak, mitigating the oil peak and not overstretching the electric power system development. It will also decrease the total transportation costs by a factor of 2 or more while increasing by the same factor the connectivity and connection strengths. The strength of multi-modal electric vehicle system comes from the fact that it is introduced gradually as a neighborhood cheap transport device grid or solar powered and gradually developed its capabilities to multi-modal transport, to recreational and amphibious vehicle. In several years the communities will learn by themselves about the utility of having rail cheap and fast transportation, the advantages of pull bands in the street to give shortcuts in mountain regions, the funicular mode advantages or on monorails. Airplane platforms or helicopter propulsion are few of the future potential options of an integrated strong connected transport system. Underwater is a rare possibility, for education and agreement mainly that may be developed to cover all the possibilities of use of the multi-modal device, while amphibious features are useful in may water shore areas. The most important is that the multi-modal features to be developed right and be mature to smoothly satisfy the market demand, and to provide the market and environment a reliable safe and sound business model.

A future transport optimization may look like the example in table 1

TABLE 1
Multi-modal transport versions analysis

| | Multi-Modal Transportation combination (see FIG. 1) | | | | | | | | | | Effectiveness calculation | | | |
|---|---|---|---|---|---|---|---|---|---|---|---|---|---|---|
| Version. | B | mRd | mR | M | A | H | AW | P | F | UW | Minutes | Transfer | Mpg | Safety |
| 1 | 20 | 25 | 50 | 100 | | | | | | | 175 | 5 | 500 | 1 |
| 2 | 10 | | | | 150 | | | 1 | | | 90 | 4 | 25 | 2 |
| 3 | | | | | | 170 | | | | | 80 | 0 | 5 | 3 |

There are shown three possible ways to produce the transport by using the infrastructure with various decisions as function of the weight of the different criteria that matters in the decision making process to cover a minimal distance of 155 miles. It shows that version 3 is 100 times more expensive than version 1 and only twice faster, with lower safety figure. Version 2 might more acceptable as cost time and safety level. Safety figures are arbitrary, and remain to be evaluated practically. It will be obvious that most of the people will prefer to spend the equivalent of $1 and extra 1 h, to minimize the potential accelerations they may receive and make the travel on cheapest version. Only in special circumstances they will use the airplane or helicopter non-ecologic propulsion to shorter the time. By the time the system will be available the gasoline might cost 3 times more, and the real cost of the trip might be illogically expensive (the 1 h difference may cost over $100). And this is only a partial analysis; more factors will also count in individual decision-making process.

### ADVANTAGES OF THE NEW SOLUTION

The present patent aims to combine various solutions in such a manner as to allow the following advantages be present simultaneously:
have very low energy consumption, achieved by reduction of masses and surfaces towards the payload's dimensions.
have the necessary autonomy achieved by adjusting the storage capability according to the needs
have fossil fuel free propulsion based mainly on solar power achieved by integration of solar panels and grid power
have comfort inside as in the actual vehicles or better—achieved by separation of the vehicle constitutive modules, the cockpit being free of vibration and pollution, with enhanced life support capabilities
have faster “commercial” speed by multi-modal resource integration, by mainly transporting the cockpit in various multi-modal systems and propulsion platforms.
Have enhanced safety, and navigation systems achieved by the cockpit design and electronics integration on board
Have multifunctional capabilities as snow, mud and slurry, amphibious and under water usage capabilities achieved by shaping the modules according to the usage desire.

The simplification comes of producing standardized propulsion units with modular batteries independent of the battery type as Li-Ion; Pb, Ni-Ion, etc.

These will be interchangeable—
What the invention brings is:

Battery
Low customized battery size in the range of 2-10 kWh
Various customized battery modules—
Short charging by Interchangeable battery modules at
   the battery tank or,
   propulsion unit level
Stairs added
Battery related system in the battery cabinet—loading discharging; measurement, diagnosis and communication
Multi-modal connectors and accessories

Propulsion
The propulsion modules are also interchangeable in order to customize the power and autonomy needs.
Various propulsion modules—from normal—to underwater sealed and low negative buoyancy
They may be interchanged as spare parts at the ends of the battery tanks
They may have independent suspension at adjustable stiffness
May be amphibious with water double function wheels or ground only
May include a extension air cushion for soft shallow water and swamps travel
May have supplementary underwater 3D displacement system
Has direction incorporated with single or double direction wheels
Light and driving systems and sensors

Connection Module
No tilt, single lateral tilt or double tilt mechanisms with controllers
Standardized connection for fast lock/unlock mechanism
Folding connection
Supplementary suspension for cockpit fixtures
Aerodynamic adjustment
Solar panel supports
Front/rear collision protection panels/grids
Cart accessories
Under connection structure multi-modal power train couplings
Under cart automatic navigation system (EM street following)

Solar Harvesting Module
Flat panel interchangeable solar panels
Foldable solar panels
Airfoil profiled panels
Independent charging panels maximizing the power by reactive impedance matching (D class electronics)

Cockpit
Variable no places and size
Aerodynamic shape, enhanced collision structure
Enhanced suspension
Standardized 3 point coupling up and down
Incorporated power missile propulsion (high trust boosters for underwater and air applications)
Standardized rear coupling
Aquatic/amphibious floating structure
Underwater sealed structure
Collision protection structure
Integrated computer system
Standardized drive by wire system
Emergency cable and hydro-mechanic systems
Light system
Air control
Additional floating system
Independent battery and redundant power source reloading from power trains

Accessories:
Secondary solar carts
   Up to 4 light carts
   Foldable structure over the main cart
   Multi-modal transportable
Under street trolley power couple
   Applied at choice at connection system
   Applied to connect the individual power trains
Under cockpit floating structure
   It is an amphibious vehicle accessory making any cockpit structure float.
External arms for underwater applications
   The special structure applied at request for underwater maintenance or other operation and safety devices in running waters.
Flying train power system—
   Flying the cockpit
   Flying the entire vehicle
   Solar panel flying system and recharging system
   Rechargeable system while flying
Maglev and rail power system
   Is an adaptor power platform running on dedicated classical rail or magnetic levitation rails and monorails in order to eliminate the mechanical friction and remain with cockpit's aerodynamic friction force mainly. A rail wheel is 5-10 times more efficient than a tire wheel, while no bumpy rail saves more energy from being dissipated by shock absorbers. A tradeoff between speed and specific energy consumption will be made in each case.

Multi-Modal Transport
ROR Container
Cable transport
Train transport
Air transport container
Desault (parachute) accessories
Mono-rail accessories for up highway connection

General Modification of Transport Concepts
The persons usually buy the cockpit, and in exceptional cases the batteries
The community owns the rest that is temporarily rented to persons for defined usage
The community may own the mono-rail computer driven taxi system having a trans-boarding at terminals from rail adapter to battery adapter A mono-rail high speed connection may drive up to 300 mph making the trans-boarding Santa Fe Albuquerque in 15 min or less.
The basic principle is switching the propulsion to get savings in time and energy, running mainly on electric power—having the capacity of pushing the individual transport cost lower towards the limit of 1 kWh/10 miles and even lower in combined multi-modal transport systems.

The average electric energy needed to transport the US 300 mil. population by an average of 20 miles/day will become somewhere between 20-100 GWd, for an average power of 25 GW, acceptable for US actual development of electric power.

### SUMMARY

The “street curve” shows that the fuel or energy consumption depends on the mass of the car, call M where M is the net vehicle mass Mᵥ plus the payload made of passenger mass and luggage Mₚₗ, the cross section on forward direction, call Sₓ multiplied by the aerodynamic coefficient call Cₓ, the friction coefficients in the transmission systems giving a force call Ft(v), where v is the car's speed.

To obtain a reduction it is necessary to act on all the parameters:

Mass has to be reduced towards Mₚₗ, Sₓ has to be reduced towards Sₚₗ, aerodynamic coefficient that takes effect at higher speeds has to be reduced towards water droplet shape value, or better, speed have has to be kept moderate, up to 60 mph.

Compared with a car structure it is possible to reduce the mass from 2 t down to ¼ ton, the aerodynamic coefficient and the rest of forces will remain constant and an increase of mileage of 4 times may be obtained, reducing the payload by 4 or by 2.

Another source of reduction is the change of the gasoline tank—thermal engine that gives an efficiency under 30% with an electric battery bank—electric motor that gives an efficiency of 60%-70% and the elimination of transmission that takes up to 10% of the power, with electric traction that takes less than 5%. This will bring another factor of 2.

Finally if that advanced vehicle was running with a 50 miles per gallon, it will be possible to run it now for a single adult person at 350-400 miles per gallon.

A gallon of fuel contains 3.85 liters×40.5 MJ/litter=150 MJ=40 kWh. A bank of 30 batteries of 12V, 100 Ah, may deliver that. This becomes very heavy; therefore autonomy of 100 miles may be obtained for only 8 batteries, at a more reasonable weight.

This autonomy may not be enough for about 5% of transportation cases.

Making these vehicles suitable for multi-modal transportation can solve this. The vehicle may have devices compatible with a specialized crane from the multi-modal vehicle loader to easy couple and take the vehicle into a specialized container.

The multi-modal transportation system is composed from a vehicle container and a passenger container traveling together on the same transport system, train, and trailer.

The carrier vehicle may recharge the vehicles stored in container from its power source or may develop auxiliary systems.

The electric vehicle has the size defined by the dimensions of the passenger trimed by the container dimensions. It will be 7 ft long and 3-5 ft wide, 4-6 ft tall, aerodynamic shaped cockpit. It will have the F1 protective features, and will have a Cₓ of 0.2-0.3 at a cross surface of about 18 sqft=2 m² loading a weight of 350 lb. and having a own weight of 100 lb. The total weight of the vehicle will be 600 lb-1000 lb loaded and 250 lb-350 lb unloaded.

The structure is similar to a 2 electric scooters reduced at the traction train with a sidecar or cockpit structure mounted between them on a dynamically gravitational adjustment system. The structure have to be aerodynamic and impact resistant similar to formula 1 racing cars.

The train structure may be as light as bicycle wheels or motorcycle wheels or scooter or even car wheels. The electric gravitational adjustment system helps the displacement in tilted surfaces and turns giving the driver a flying feeling.

The solar panel above is reducing the aerodynamic coefficient by as much as 20% but brings a relief for electric power being suitable for many short distance trips without refueling.

To increase the day light autonomy the vehicle may trail up to four very light solar energy harvesting carts trimmed at container's width in order to obtain kWw range power needed for its long distance displacement during the day in a 250 miles range.

### BRIEF DESCRIPTION OF THE DRAWINGS

FIG. 1—Front rear view of the vehicle

FIG. 2 The electric vehicle turning

FIG. 3—The vehicle on tilted ground

FIG. 4—Tilt adjustment system

FIG. 5—Bicycle/motorcycle structure adaptation system perspective view

FIG. 6—Bicycle/motorcycle structure adaptation system front view

FIG. 7—Electro-scooter adaptation system perspective view

FIG. 8—Autonomous solar vehicle system

FIG. 9—modular cargo system

FIG. 10—The multi-modal electric transportation principle

FIG. 11—The electronic control system

FIG. 12—The electric vehicle in main multi-modal propulsion modules

FIG. 13—The magnetic levitation propulsion system

FIG. 14—The foldable connection structure compaction for multi-modal transport or storage.

FIG. 15—Longitudinal section through the modular solar electric vehicle system

FIG. 16—The options list or menu with various configurations allowed by the advanced modularity

FIG. 17—The cockpit is mounted on a power train

FIG. 18—Cost and Mileage as function of transport means.

FIG. 19—The performance of the transport mode with respect to mileage and speed

FIG. 20—Air platforms attachment

### SUMMARY OF FIGS. AND THEIR DESCRIPTIONS

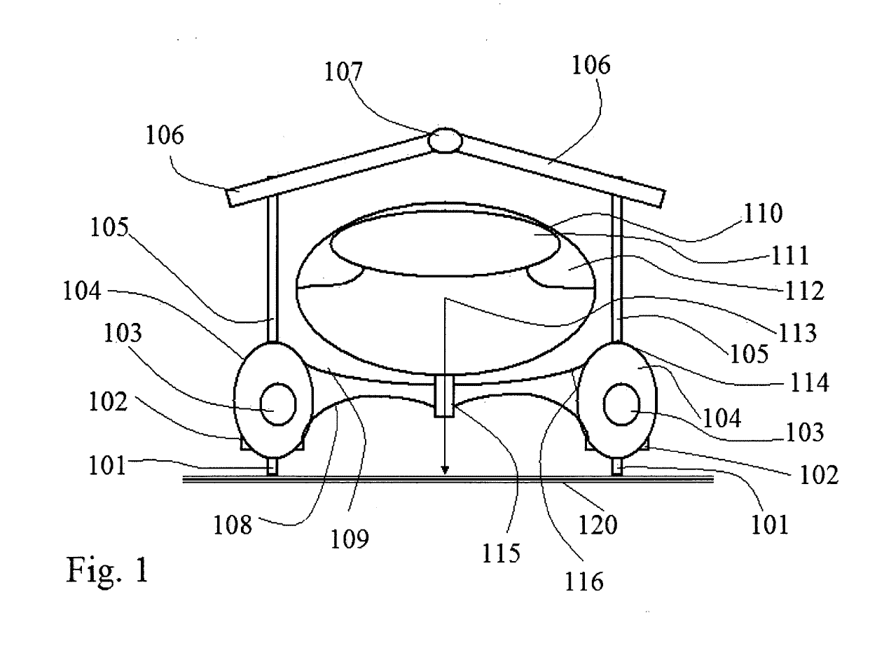

FIG. 1—Front Rear View of the Vehicle
101—Wheel structure and tire
102—Wheels power structure
103—Head aerodynamic profile and lights
104—Aerodynamic functional case, with multimodal adaptor
105—Lateral sunroof support
106—Solar harvesting panel
107—Top hinge
108—Lower Elastic transversal bridge
109—Upper elastic bridge
1010—External cockpit case
1011—Windshield
1012—Cockpit door
1013—Cockpit reinforcement safety structures
1014—Solar panels lateral supports adjustments
1015—Central cockpit elastic fixtures with tilt follower system
1016—Tilt adjustment system
1020—Ground (horizontal)

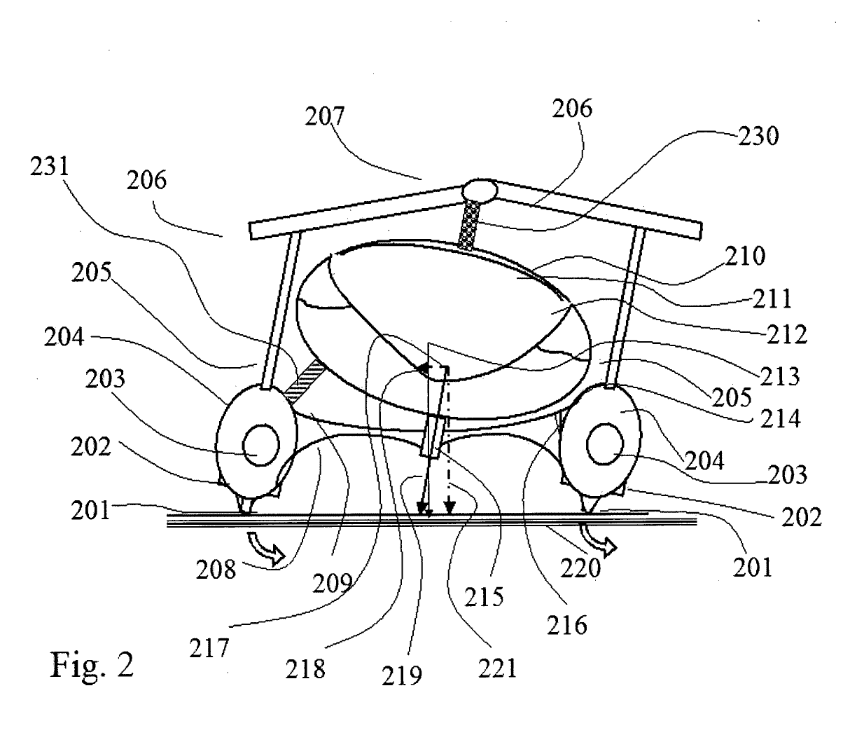

FIG. 2 The Electric Vehicle Turning
2001—Wheel structure and tire
202—Wheels power structure
203—Head aerodynamic profile and lights
204—Aerodynamic functional case, with multimodal adaptor
205—Lateral sunroof support
206—Solar harvesting panel
207—Top hinge
208—Lower Elastic transversal bridge
209—Upper elastic bridge
2010—External cockpit case
2011—Windshield
2012—Cockpit door
2013—Cockpit reinforcement safety structures
2014—Solar panels lateral supports adjustments
2015—Central cockpit elastic fixtures with tilt follower system
2016—Tilt adjustment system
2017—Center of mass
2018—Centripetal force
2019—Resultant force projection on base
2020—Ground (horizontal)
2021—Gravity force
2030—Upper support—elastic dumper and shock absorber
2031—lateral shock absorber, dumper

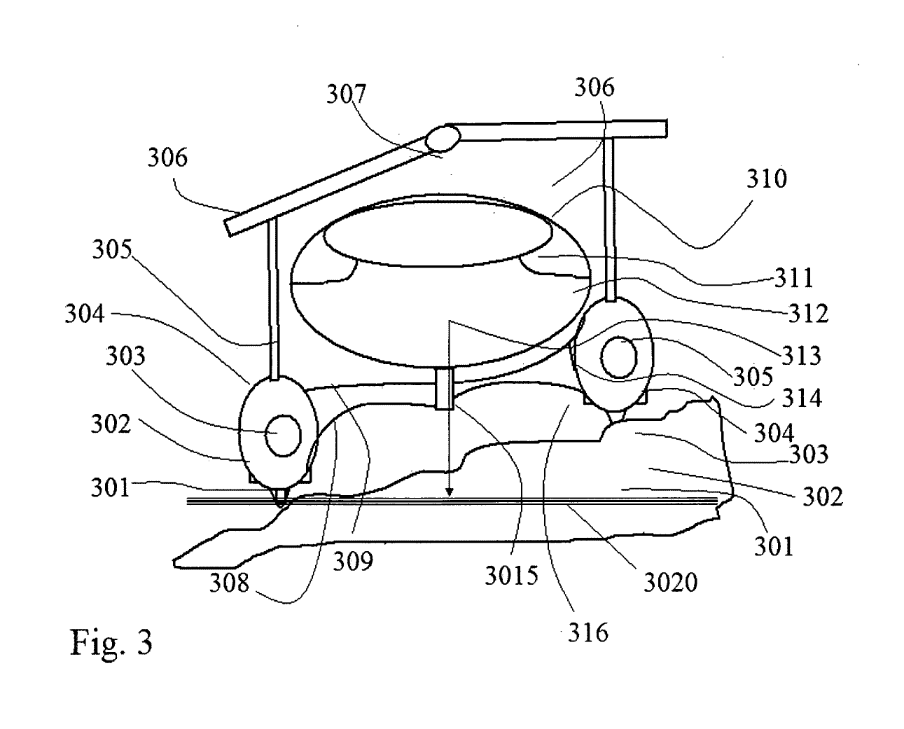

FIG. 3—The Vehicle on Tilted Ground
3001—Wheel structure and tire
302—Wheels power structure
303—Head aerodynamic profile and lights
304—Aerodynamic functional case, with multimodal adaptor
305—Lateral sunroof support
306—Solar harvesting panel
307—Top hinge
308—Lower Elastic transversal bridge
309—Upper elastic bridge
3010—External cockpit case
3011—Windshield
3012—Cockpit door
3013—Cockpit reinforcement safety structures
3014—Solar panels lateral supports adjustments
3015—Central cockpit elastic fixtures with tilt follower system
3016—Tilt adjustment system
3017—Center of mass
3018—Centripetal force
3019—Resultant force projection on base
3020—Ground (tilted)
3021—Gravity force

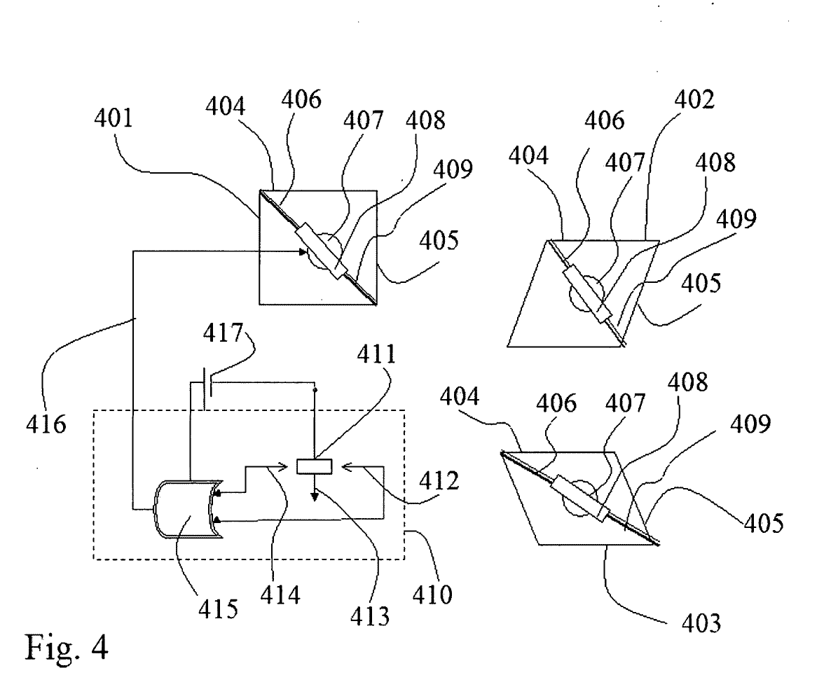

FIG. 4—Tilt Adjustment System
401—The force parallelogram at straight angle
402—The force parallelogram tilted right
403—The force parallelogram tilted left
404—The horizontal rod
405—The vertical rod
406—The diagonal adjustable upper rod
407—Electric motor
408—Gearbox reducer
409—The diagonal adjustable lower rod
410—Automatic tilt adjustment system
411—Gravity vector direction detector
412—Right detector
413—Tilt value transducer
414—Left detector
415—processor unit
416—actuator signal
417—battery

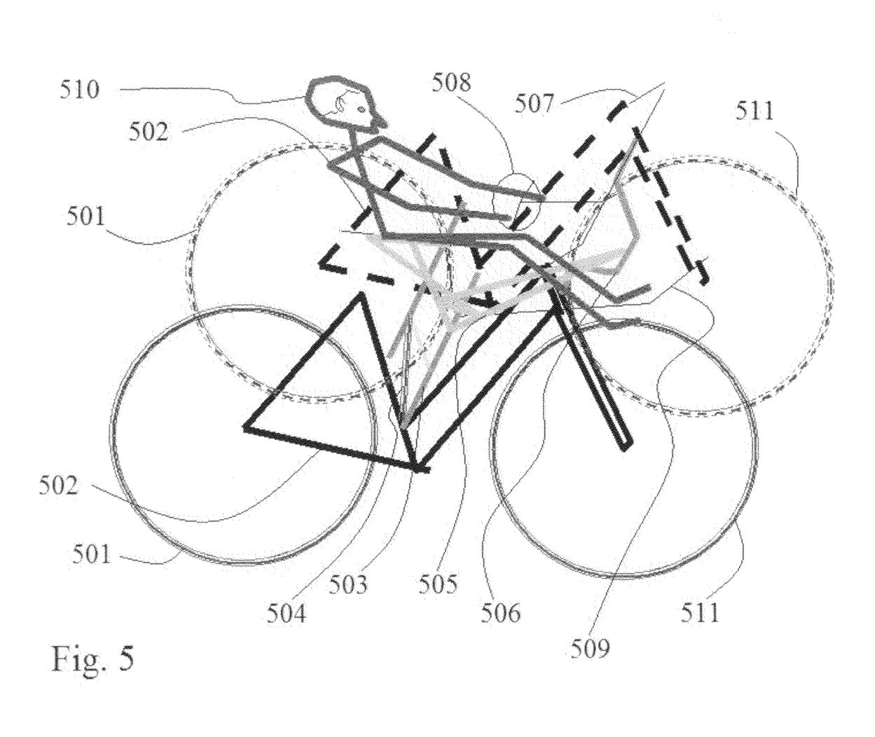

FIG. 5—Bicycle/Motorcycle Structure Adaptation System Perspective View
501—rear wheel and tire
502—chassis—skeleton of the bicycle
503—transversal tube in horizontal hinge
504—force parallelogram for tilt adjustment
505—cockpit support structure with tilt adjustment and shock absorbers
506—Front transverse bar with horizontal hinge
507—Direction control system
508—Stirring system
509—Driver's deck
5010—Driver
5011—Front wheel

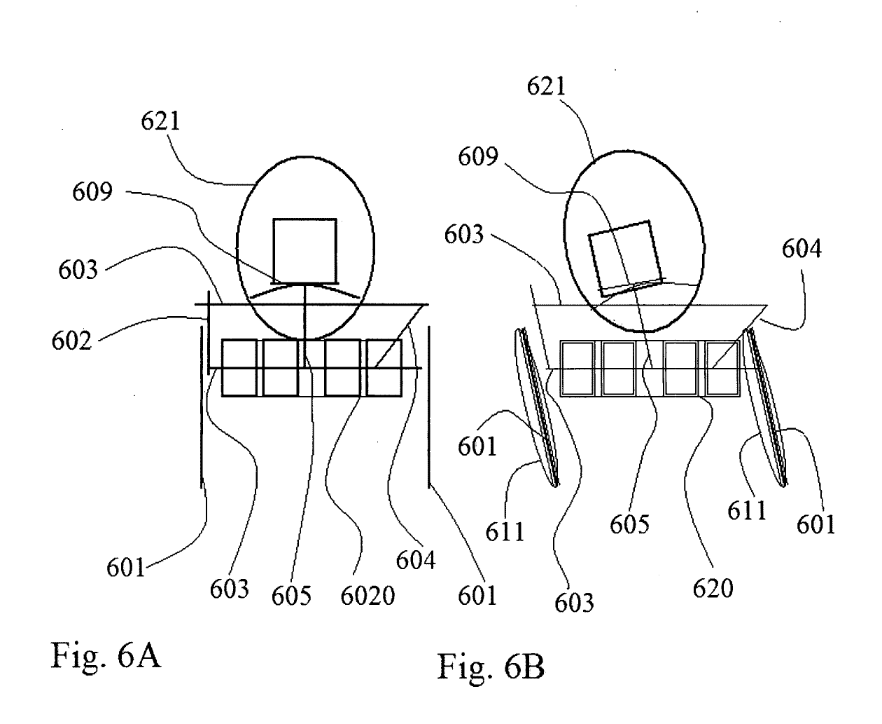

FIG. 6—Bicycle/Motorcycle Structure Adaptation System Front View
601—rear wheel and tire
602—chassis—skeleton of the bicycle
603—transversal tube in horizontal hinge
604—force parallelogram for tilt adjustment
605—cockpit support structure with tilt adjustment and shock absorbers
609—Driver's deck
6011—Front wheel
6020—Battery bank
6021—Cockpit

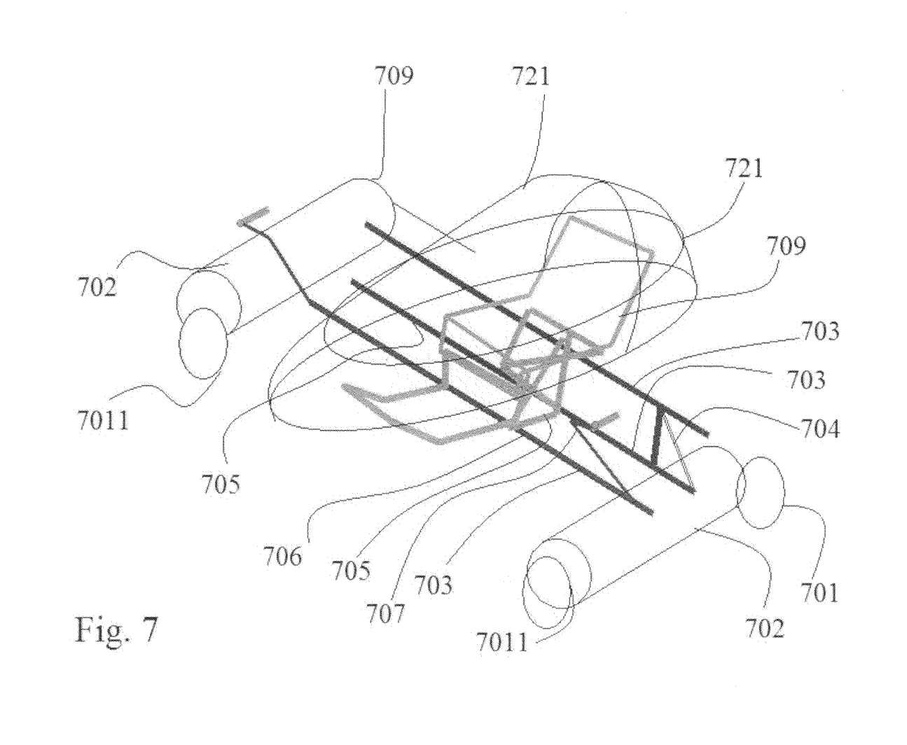

FIG. 7—Electro-Scooter Adaptation System Perspective View
701—rear wheel and tire
702—chassis—skeleton of the bicycle
703—transversal tube in horizontal hinge
704—force parallelogram for tilt adjustment
705—cockpit support structure with tilt adjustment and shock absorbers
706—Front transverse bar with horizontal hinge
707—Direction control system
709—Driver's deck
7011—Front wheel
7021—Cockpit

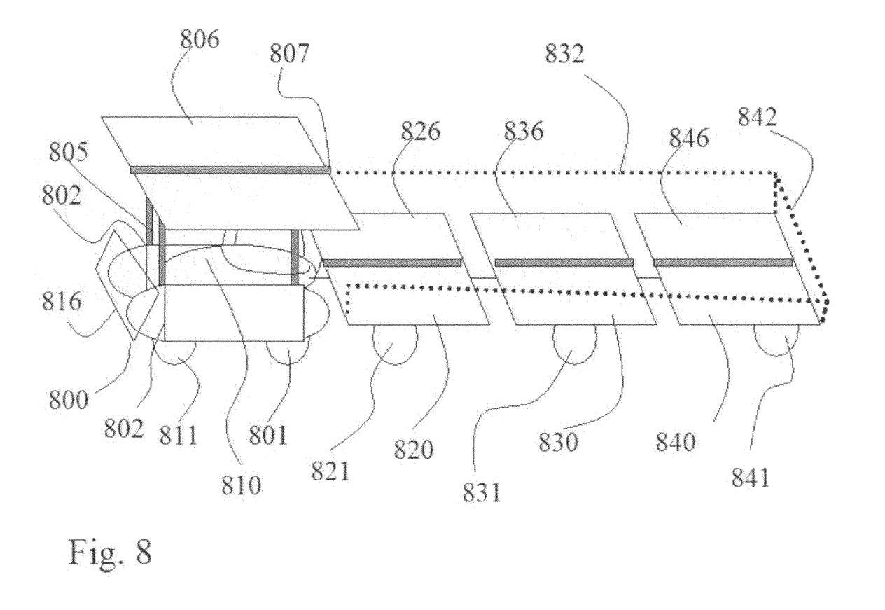

FIG. 8—Autonomous Solar Vehicle System
800—The electric vehicle trailer
801—Electric vehicle rear wheel
802—Aerodynamic power train
805—Solar roof adjustable support
806—Solar harvesting panel
807—Roof hinge
8010—Cockpit
8011—Electric vehicle front wheel
8020—First Solar cart
8021—First cart forward wheel
8026—Cart solar harvesting tile
8030—Second solar harvesting cart
8031—Second cart median wheel
8032—Lateral wind dumper and people protection
8036—Cart solar harvesting tile
8040—Third solar cart
8041—Third cart rear wheel
8042—rear protection and wind dumper
8046—Solar harvesting tile

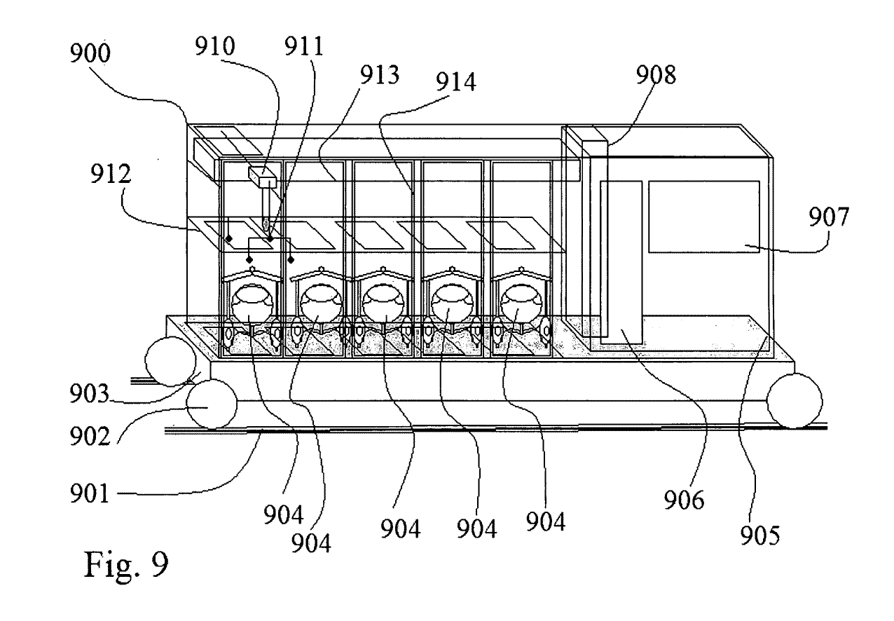

FIG. 9—Modular Cargo System
900—ROR Container system
901—Ground or rail
902—Wheels of the carrier vehicle
903—Carrier platform
904—Multimodal electric vehicle
905—Passenger container
906—Door—stairs system
907—window
908—Multifunctional center
9010—Multimodal crane system
9011—Pulley with multimodal adaptor
9012—Platform with parallelogram crane system
9013—Multimodal crane sliding frame
9014—Multifunctional door/ramp

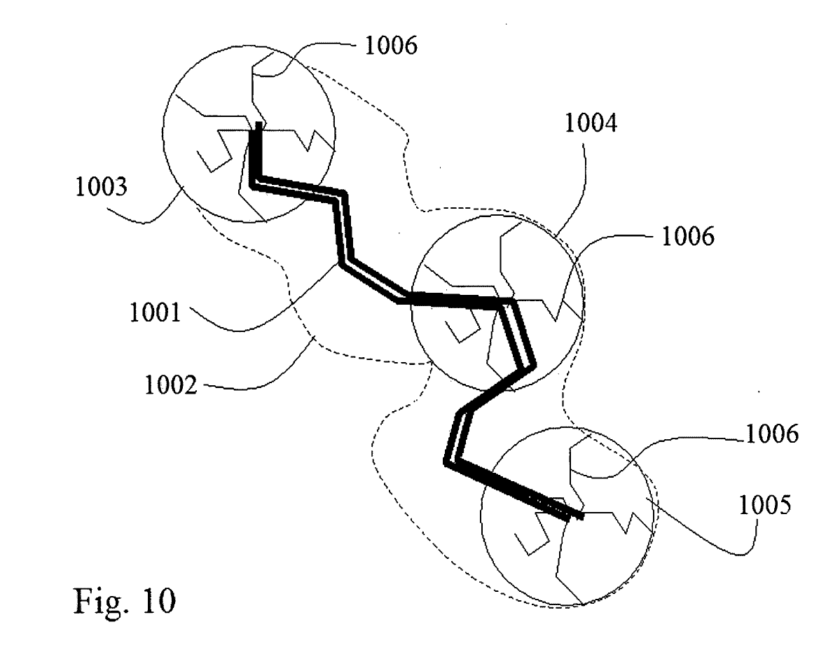

FIG. 10—The Multi-Modal Electric Transportation Principle
1001—Highway or railroad path or a combination rail and road
1002—The transportation coverage envelope
1003—Departure station electric multi-modal car autonomy surface coverage
1004—Intermediary station electric multi-modal car spreading range
1005—terminal station electric multi-modal car spreading range
1006—local road

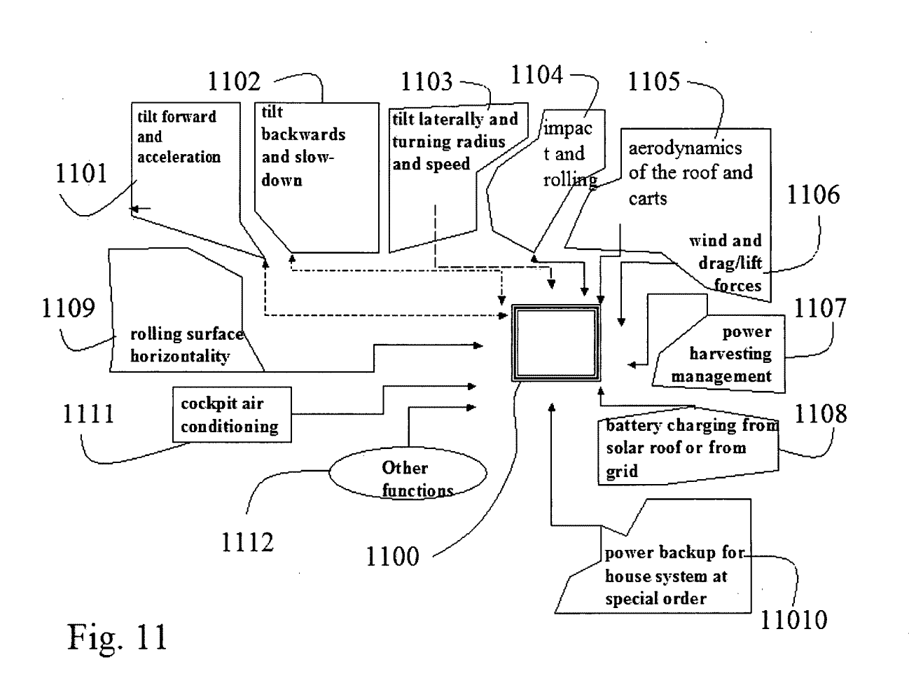

FIG. 11—The Electronic Control System
1100—Central processor unit
1101—Forward tilt acceleration module
1102—Rear tilt and slow-down module
1103—tilt laterally and turning radius and speed control module
1104—impact and rolling modulus
1105—aerodynamics of the roof and carts module
1106—wind and drag/lift forces at carts system
1107—power management and solar energy harvesting control module
1108—battery charging from solar roof or from grid
1109—rolling surface horizontality control
1110—power backup for house system at special order
1111—cockpit air conditioning
1112—Other functions modules

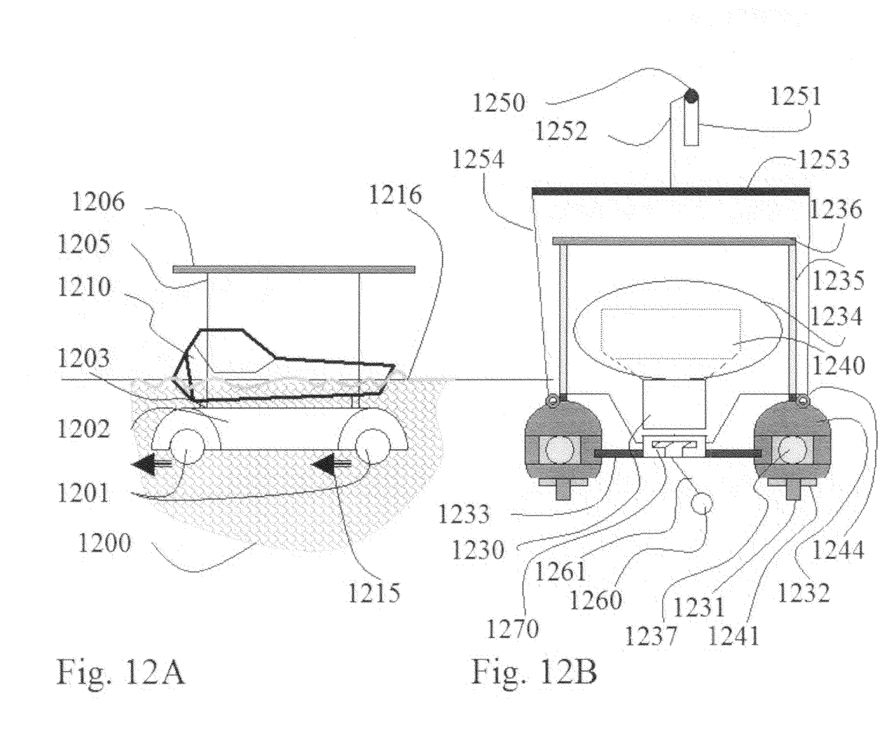

FIG. 12—The Electric Vehicle in Main Multi-Modal Propulsion Modules
1200—the multi-modal electric vehicle floating on water.
1201 fins for propulsion
1202—The power trains
1203 The connection system
1205 The polls with adjustable height
1206 The sun harvesting modules
1210 the hydrodynamic designed cockpit
1215 Water jets
1230 the floating structure
1231 The wheels have tires and a finned structure
1232 The propulsion modules with the forehead
1233 The connection structure
1234 The vehicle's cockpit made in a eggshell design.
1235 The poles
1236 the solar harvesting panels
1237 headlight, position and direction signal lights.
1240 The vehicle's cockpit made in a stealth design or
1241 coated in hydrophobic material as PTFE for water, mud or snow propulsion.
1244 multi-modal adaptors
1250 the support cable
1251 the pulley wheel
1252 The cable in a rail crane
1253 specialized crane adaptor, having
1254 4 cables or bars
1260 street integrated cable propulsion
1261 cable
1270 the rail traction adaptors, or the Electro-Magnetic wire pathfinder device

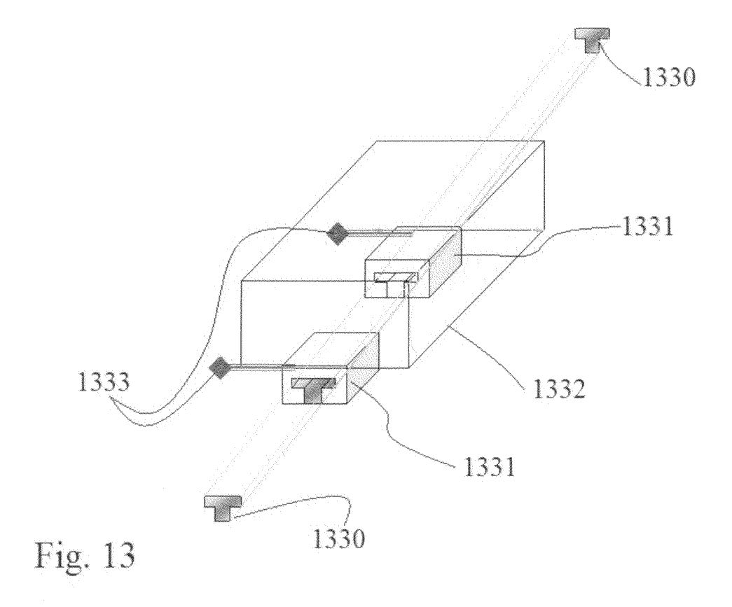

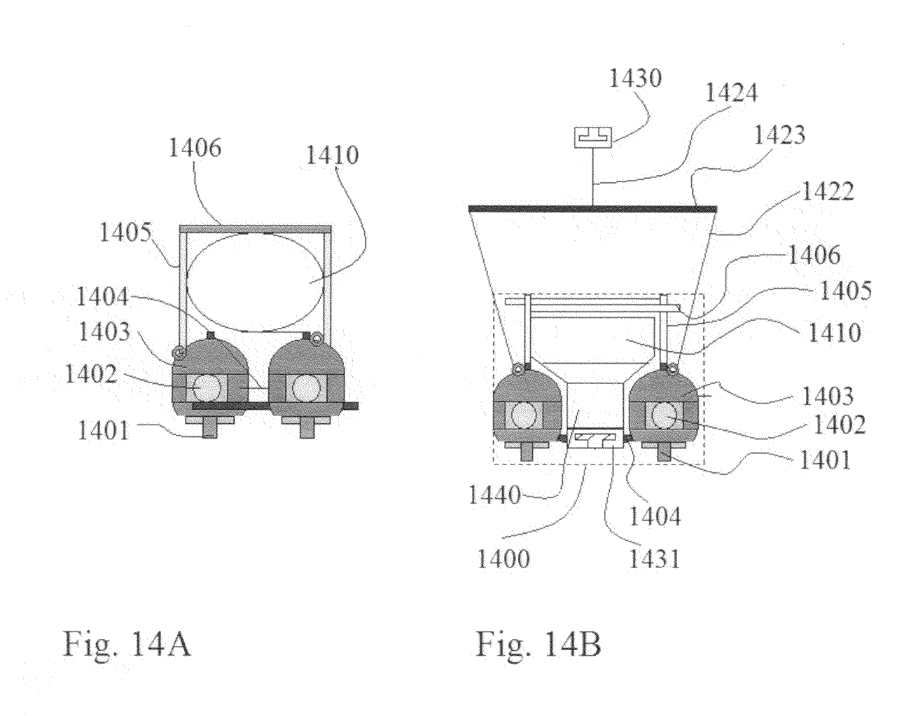

FIG. 13—The Magnetic Levitation Propulsion System
1330 the profiled rail,
1331 the magnetic propulsion modules
1332 the structure
1333 the power harvesting units trolleys

FIG. 14—The Foldable Connection Structure Compaction for Multi-Modal Transport or Storage.
1401 the wheels
1402 The front and rear modules
1403 The propulsion modules
1404 the multi-modal adaptors connection module
1405 The pillars holding the solar harvesting panels
1406 the solar panel
1410 stealth shaped cockpit
1422 hooks on cables.
1423 the crane adapter
1424 the lifting cable.
1430 a rail training system with crane
1440 a floating module

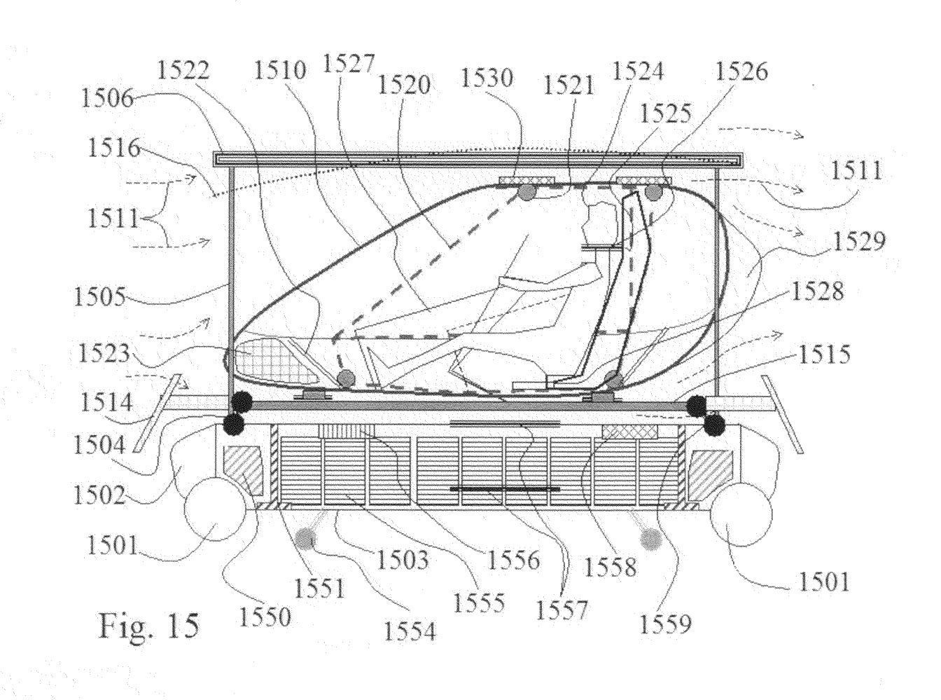

FIG. 15—Longitudinal Section Through the Modular Solar Electric Vehicle System
1501 the wheel, suspension, direction and electric motor for propulsion
1502 The wheel module
1503 the battery modules autoportant/self-sustaining structure
1504 The connection system/module
1505 the solar panel poles
1506 the solar array
1510 The cockpit
1511 The airflow
1514 laminar aerofoil profiled grill
1515 the central axe
1516 profiled solar panels
1520 the pilot/driver cage
1521 elastic vibration absorbing components
1522 the glides
1523 a shock energy absorbing material
1524 a 7 ft male
1525 a 4 ft female or child.
1526 The seat
1527 the steering and controls
1528 batteries
1529 inflatable pillow
1530 the standardized fast locking fixtures
1551 motors' regulators with the fast locking fixture
1554 support wheels, grips
1555 batteries
1556 the battery power regulators
1558 power management and charging system
1559 The multi-modal adaptors

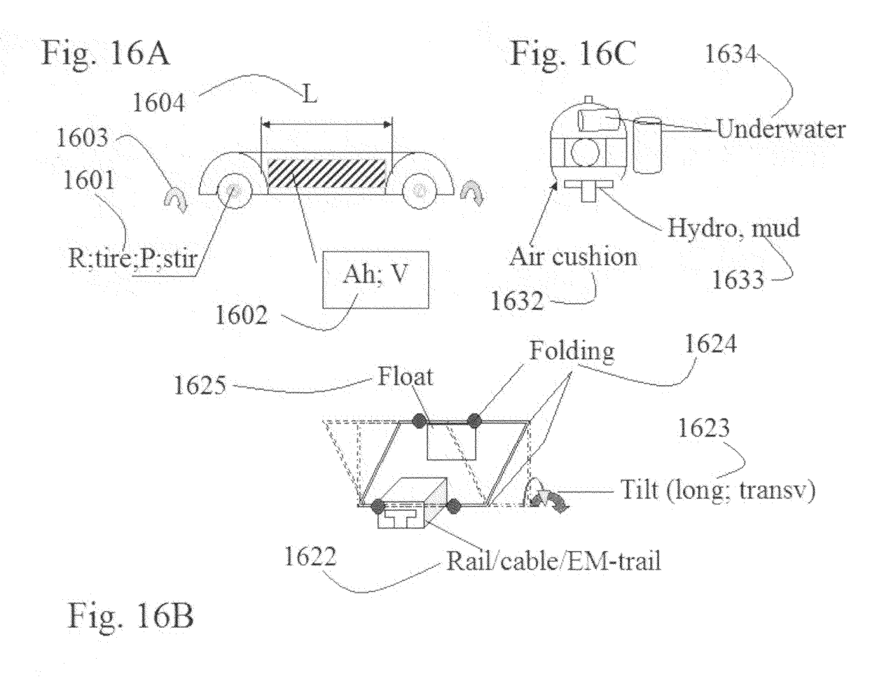

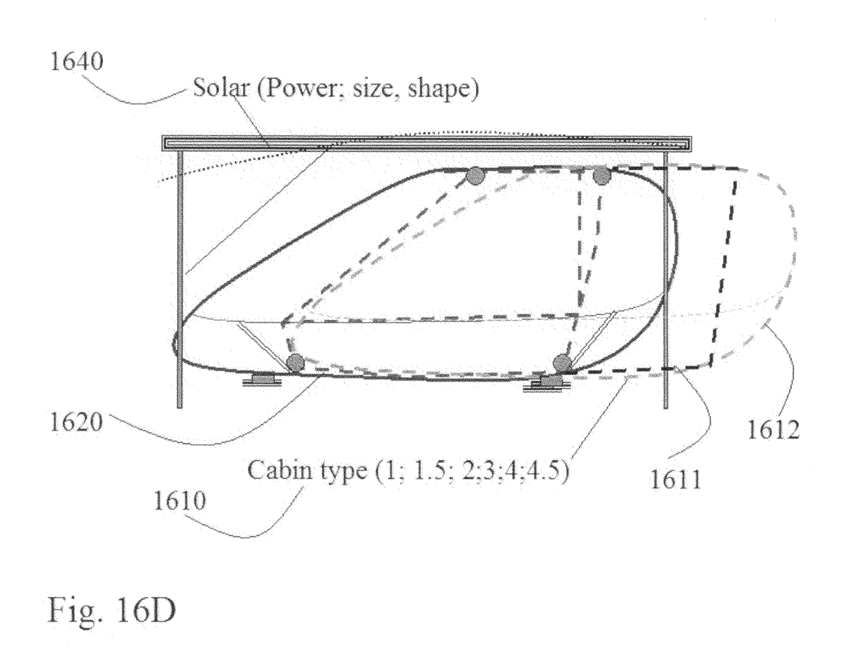

FIG. 16—The Options List or Menu with Various Configurations Allowed by the Advanced Modularity

FIG. 16A shows the battery propulsion train options.
1601 the propulsion wheels modules
1602 The battery tank
1603 The power of the wheel and the stirring
1604 The connection system
   FIG. 16B the connection module customization.
1604 The connection length L
1622 a power module as rail, or cable traction or an electromagnetic cable follower, or
1623 the tilt freedom degrees
1624 folding structure.
1625 floating structure street power loading trolley.
   FIG. 16C special options for amphibious and underwater applications.
1632 air cushion to glide on mud and shallow waters
1633 hydro, mud, snow fin profiled wheel
1634 underwater displacement systems, and possible a remote arm
   FIG. 16D selections for the cockpit and solar panels.
1610 The cabin types
1611 extension module
1612 termination body
1640 the solar power harvesting system

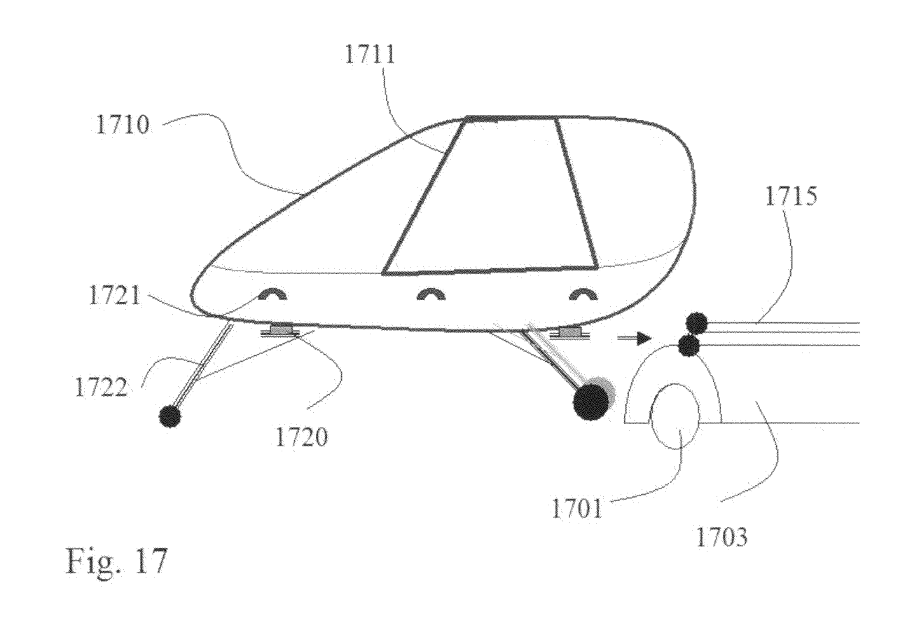

FIG. 17—The Cockpit is Mounted on a Power Train
1701—the power train.
1703—the power train
1710—the cockpit
1711—the door
1715—the locker axis
1720—the lockers
1721—cockpit's set of handlers
1722—3-wheeled foldable lockable legs

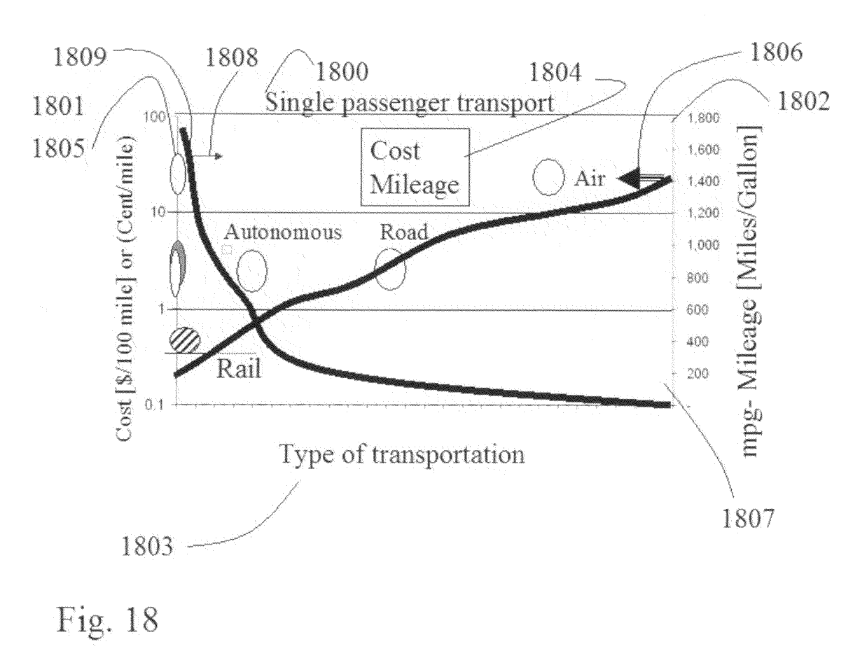

FIG. 18—Cost and Mileage as Function of Transport Means.
1800—Single passenger equivalent transport efficiency chart
1801—Cost per passenger per mile in (cents/mille) or [USD/100 milles]
1802—Specific energetic equivalent consumption in mpg
1803—Type of transportation
1804—Legend
1805—Cost range for various transport systems
1806—Arrow showing that the large bars are read on Cost logarithmic axis
1807—Cost bar
1808—Arrow showing that the mileage narrow bar is read on the mpg axes
1809—Mileage narrow bar

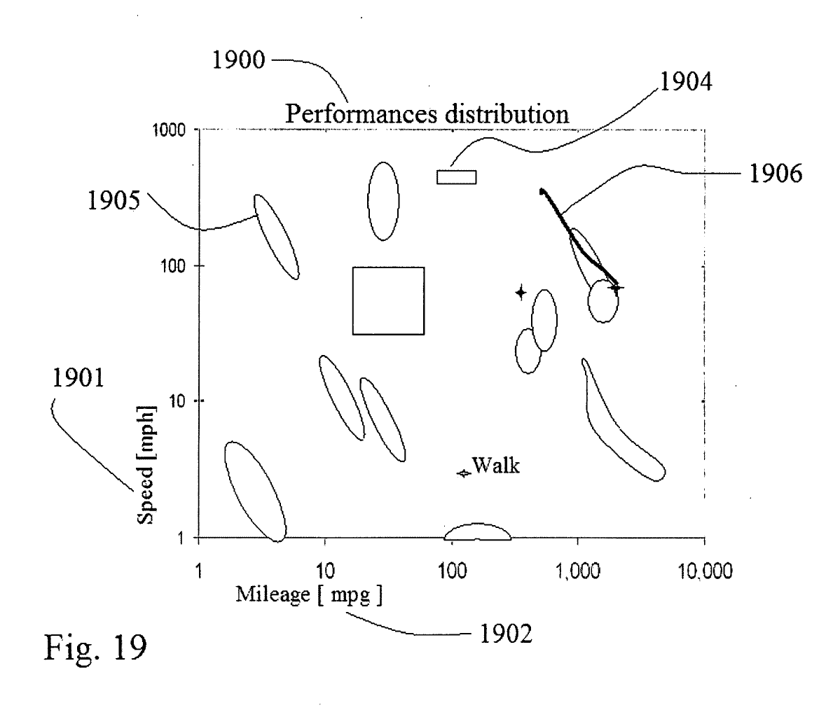

FIG. 19—The Performance of the Transport Mode with Respect to Mileage and Speed
1900—Performance distribution of the transportation means
1901—Transportation speed
1902—Mileage
1904—Diamond point showing the position of the statistics data
1905—Ellipsoid showing the domain of performance of possible multi-modal device
1906—Line showing the correlation speed-mileage

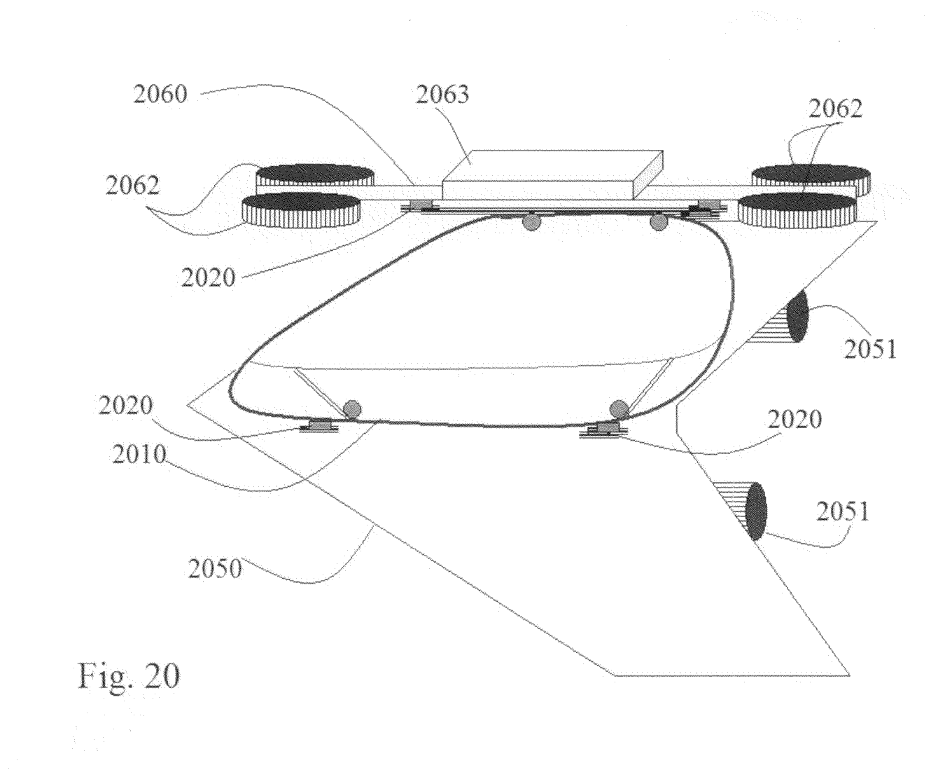

FIG. 20—Air Platforms Attachment
2010—The cockpit
2020—The multi-modal lockable fixture
2050—Flying UAV wing
2051—Propulsion turbines
2060—Helicopter skeleton structure
2062—Propulsion turbo-fans
2063—Motor-generator and fuel tank

### DETAILED DESCRIPTION

FIG. 1—Front rear view of the vehicle is looking almost the same being dominated by the aerodynamic shape of the body.

There are two propulsion wheels systems made by the transformation of a two-wheeler (scooter, bicycle, motorcycle, or customized) vehicles chassis with the wheel and tire 101 having a variable size between 8-24″. The Wheels power structure 102 is made of a chassis holding the two wheels together similar to a motorcycle, bicycle or scooter body, loaded with the electric motors, suspension, braking systems and batteries banks. It is desired to put almost the weight near to ground to increase its stability. Therefore the most near structure is the scooter. It has the disadvantage of not performing well on rough terrain due to low ground guard, touching ground obstacles. These are the power modules. The power modules are covered by an aerodynamic profile case 104 with headlights 103 giving a low aerodynamic coefficient similar to o missile and the center of mass placed at about ⅖ of the wheel diameter.

On the aerodynamic case there are multi-modal transporter adaptor structures as hook spaces and wheel lockers and fixed supports that once opened blocks the structure in place. That also serves as security features for the parked vehicle being key unlocked.

The aerodynamic functional case, with multi-modal adaptor 104 also serves as stair for the driver and support of the solar panels.

The lateral sunroof support 105 is rigid to the power train platform, tilting solitary, but is articulated on the roof by a top hinge 107 supporting the solar harvesting panel 106.

There are two identical power structures connected by a distributed parallelogram structure that allows them tilt parallel. The structure is made of more than two bridges two lower Elastic transversal bridge 108 and one or two upper elastic bridge 109. The elasticity is moderate allowing shock absorption. In the center a structure connects parallel creating the central cockpit elastic fixtures with tilt follower system 1015.

This fixture contains shock absorbers and elastic suspension that decouples the resonance frequency of the transversal supports 108 and 108.

The external cockpit case 1010 has the capability to tilt parallel with the driving power trains. It has an aerodynamic shape, looking like an egg with continuous curved structure or in stealth format made of flat surfaces. It has am windshield 1011 connected to the access door that may have a sweeper.

The cockpit door 1012 may be made lateral, bi-lateral or roof integrating the windshield. The cockpit reinforcement safety structures 1013 similar with what is used in formula 1 or avionics have the role to create an elastic deformable structure to absorb the impact energy and protect the driver.

The Solar panels lateral supports adjustments 1014 have an important role in aerodynamics of the system as well in system compaction for multi-modal transportation.

A very important feature is the tilt adjustment system 1016 that controls the verticality of the system on the horizontal ground 1020, during turns in two wheeler style or tilted ground. This keeps the forces inside the support base the vehicle mainly skidding lateral in overspend but not rolling. A force parallelogram actuator 1016, controlled by an electronic system, makes the adjustment of the weight and inertial forces.

FIG. 2 shows the electric vehicle turning on horizontal surface 2020.

The tilting mechanism 2016 together with the longitudinal bushing in the transversal parallelogram makes that the force in the tires and wheel structure 201, 2011 to be equal giving minimal axial stress.

The wheels power structure 202 and the head aerodynamic profile and lights 203, contained in aerodynamic functional case, with multimodal adaptor 204, with lateral sunroof support 205 are tilting parallel together, living the solar harvesting panel 206 mainly parallel to the ground with slight changes due to the top hinge structure 207.

The lower Elastic transversal bridge 208 and the upper elastic bridge 209 are moving parallel to each other making the central cockpit elastic fixtures with tilt follower system 2015 tilt according the adjustment made by the tilt adjustment system 2016. This system compensates for the lateral forces but it has to be strongly enhanced to compensate for the longitudinal forces occurring during accelerations and slow downs.

An enhanced structure is achieved using an upper support—elastic dumper and shock absorber 2030 that takes most of the cockpit weight. The external cockpit case 2010 will be supported in an reinforced roof 207 and the bottom support 2015 having lateral shock absorbers end of range stoppers and vibration dumpers 2031. In this system the weight force 2021 acting on the cockpit's center of mass 2017 is combining with the centripetal force 2018 keeping the resultant force 2019 in the center of the rectangle base made by the four wheels 201,2011. The windshield 2011 part of the cockpit door 2012 protects the driver on bad weather and allows air-conditioning system inside powered by the solar-panels 2014.

The cockpit reinforcement safety structures 2013 are used to support the insulation of the cockpit in order to minimize the heat exchange.

The solar panels lateral supports adjustments 2014 provides good aerodynamics and shadow, helping the auxiliary water evaporation cooling system work better reducing the need for the electric compressor air conditioning system and saving electric power.

FIG. 3 shows the vehicle on tilted ground 3020 with the wheel structure and tires 301 and wheels power structure 302 at different levels. The tilt adjustments system 3016, applies forces in the parallelogram of force that applies it to lower elastic transversal bridge 308 and to upper elastic bridge 309 making the verticality of the car.

Each head aerodynamic profile and lights 303 module with the aerodynamic functional case, with multimodal adaptor 304 are placed at different levels. The lateral sunroof support 305 and solar harvesting panel 306 are placed in a position on average parallel with the ground lateral tilt moderated by the top hinge 307.

The external cockpit case 3010, including the windshield 3011, cockpit door 3012, cockpit reinforcement safety structures 3013 are maintained in a near vertical position, compensated lateral by the central cockpit elastic fixtures with tilt follower system 3015.

The solar panels lateral supports adjustment 3014 has an effective role in aerodynamic flow adjustment and car compaction during multi-modal transport.

FIG. 4 shows the tilt adjustment system acting on a force parallelogram that can be at straight angle 401, tilted right 402, and tilted left 403. It acts on the vertical arm by connecting the vertical rod 405 to it firmly and the horizontal arm by firmly connecting the horizontal rod 404.

The diagonal is adjusted by screwing the diagonal adjustable upper rod 406, and the diagonal adjustable lower rod 409 into the gearbox reducer 408 under the control of the electric motor 407. If it turns one way it shortens the diagonal therefore the structure tilts right, while turning in opposite direction the diagonal elongates and the structure tilts left. A controller electronic unit 415 drives the motor.

The automatic tilt adjustment system 410 is composed of a gravity vector direction detector 411, that has a right direction detector 412, a left direction detector 414, a tilt value transducer 413 and a processor unit 415.

The gravitational detector 410 may be made of a pendulum with electric contacts, a tilt sensor, with analogical output, or a combination of wheel force sensors. The signal is transmitted to an actuator-processing unit that takes the signal and generates the actuator signal 416 that controls the electric motor 407. All the equipments are powered from the batteries 417 placed in the battery tanks.

FIG. 5 shows a easy procedure to adapt a Bicycle/motorcycle structure to create the propulsion train for the vehicle in a perspective view.

There are two bicycles motorcycles in parallel composed of rear wheels 501, front wheels 5011, the bicycle/motorcycle chassis or skeleton 502. Transversal tubes 503 connected to skeletons by horizontal axis hinges connect these two units, allowing them tilt laterally maintaining the parallelism.

A force parallelogram for tilt adjustment 504 is setting their lateral position by adjusting its diagonal. In the middle of the transversal tubes 503 is connected the cockpit support structure with tilt adjustment and shock absorbers 505 also using hinges.

There are necessary more than two transverse bars from which at least one in front. The front transverse bar with horizontal hinge 506 needs to have such a profile to accommodate the front wheels turning space. A direction control system 507 connected to the front wheels by levers and to the stirring system 508 fixed on the driver's deck 509 allows the driver 5010 to set the direction.

FIG. 6A shows a bicycle/motorcycle structure adaptation system front view in order to see the transversal structure details. When it goes straight the rear wheel and tire 601 follows the front wheel 6011.

The chassis—skeleton of the bicycle/motorcycle 602 stays vertical.

When the car takes turns FIG. 6B the front wheel 6011 turns and the transversal tube in horizontal hinge 603 is pushed by the force parallelogram for tilt adjustment 604 to follow the forces resultant.

The cockpit support structure with tilt adjustment and shock absorbers 605 follows the skeleton tilt adjusting the position of driver's deck 609 and cockpit 6021.

The battery bank 6020 is placed as low as possible to lower the center of mass and increase stability. As a mater of evolution in vehicle technology, the system looks like a sidecar placed on two parallel motorcycles, but following the motorcycle behavior.

FIG. 7 shows the electro-scooter adaptation system in perspective view, as an equivalent structure to the motorcycle or bicycle. The rear wheel and tire 701 id the drive wheel, but all wheels may be drive wheels.

The chassis—skeleton of the scooter 702 is very low being an advantage on pavement as with the supplementary batteries on deck the center of mass comes very low, giving stability. The aerodynamic shape of a 3 ellipsoids is near fighter plane or missile value.

The transversal tube in horizontal hinge 703 connected to the force parallelogram for tilt adjustment 704 adjusts the dynamic position of the cockpit support structure with tilt adjustment and shock absorbers 705.

The front transverse bar with horizontal hinge 706 stabilizes the direction control system 707 connected at the driver's deck 709 acting on the front wheel 7011.

The cockpit 7021 may be a single one placed in center or two placed on each scooter, with a single driving command. Up to 3 cockpits may be placed or a single several persons larger one may be attached on the power train.

FIG. 8 shows an autonomous solar vehicle system made of a plurality of solar harvesting units on wheels. Considering the irradiance of one sun of about 100 W/sqft and the maximal surface of 7 f×5 ft=35 sqft and being irradiated with a power of 3.5 kW, from which it may harvest as electricity only 300 W in average, while each electric motor has about 700 W, maximal power, a need of another 3 extra panels is required to provide the necessary power for autonomous displacement under full sun, with an average speed of 40 miles/h, driving to a sun autonomy of about 250 miles/day. This may be completed with another 100 miles from the battery banks.

The electric vehicle trailer 800 has the capability to trail 3-4 light carts, with the main purposes to carry modules less than 7 ft long and 5 ft wide that can be loaded in the multi-modular transportation container.

The front vehicle is made of the aerodynamic power train 802, having aerodynamic wheels front 8011 and rear 801, each, the solar roof adjustable support 805 holding solar harvesting panel 806 that have some freedom in the roof hinge 807 that prevents the solar panel dynamic stress.

The cockpit 8010 is almost unchanged but its lower transversal arm holds the hook for the carts. There can be up to four solar carts shorter than 7 ft. that have the capability of being packed one over the other on the roof.

The first solar cart 8020 has the wheel forward 8021 being balanced by the hook, and the middle cart 8030 that has the light wheel 8031 placed on a median position. The last cart 8040 has the wheels placed at the rear 8041. All these carts carry solar harvesting tile 8026, 8036, 8046 almost similar to those of the electric car in front 806.

The central cart may be design to accept some extra-luggage under the solar tiles having a specialized platform. The system has lateral wind dumper and people protection 8032 that prevents the trailer being raised by lateral wind, and a rear protection and wind dumper 8042, that improve the aerodynamics and smoothes the system displacement.

FIG. 9 shows an exemplification of multi-modal transportation system composed from modular cargo based on ROR Container 900 standardization, for road or rail 901.

The idea is that in spite the system has good equivalent mileage, it turns more effective to cover large distances with spread areas to use a specialized trailer to carry up to 10 vehicles simultaneously using a combination of rail and road.

The travelers are embarking at one point and may be transferred on train without further changes, than back on truck up to destination. The container, is loaded on a standard carrier vehicle that have the wheels 902 of the carrier platform 903 that may be standard for rail or road.

The standardized container may be split in two, a ¾ partition to load the electric car and solar carts 904, and a ¼ partition for drivers of the carts. At their choice they may stay in the cart and sleep or come in the passengers' partition 905 and spend the time.

The passenger partition is equipped with a 8 ft multi functional door—stair 906 to allow the passenger get of the trailer or train in good conditions and windows 907, having inside a multifunctional enclosure 908 for entertainment and comfort.

The multimodal electric vehicles 904 are loaded in the trailer directly using a multimodal crane system 9010 gliding on multimodal crane sliding frame 9013 with pulley multimodal crane adaptor 9011 that can be connected directly to the vehicle's multimodal adaptors or may use the container's multifunctional door/ramp 9014 and for the upper stage a complementary platform with parallelogram crane system 9012, that makes the vehicle or the solar carts be stored easily.

The specialized door/ramp 9014 makes possible the usage of the system on any terrain without specialized loading/unloading ramps. The advantages of this system is that reduces the traffic, is increasing the autonomy and provides up to a factor of 3 higher travel speed. The disadvantage is that it reduces the capacity of the carrier vehicle by a factor of 5 to 10, which will be reflected in the transportation cost. A better alternative will be travel and rent electric vehicles for short local trips.

For railway alternative is possible to use full multimodal electric vehicle containers and passenger wagons for electric car drivers together with the rest of the passengers.

FIG. 10 shows the multi-modal electric transportation principle that makes this solution a competitive future alternative of long distance transportation on highway or railroad path or a combination rail and road 1001 with local spread area.

The transportation coverage envelope 1002 is the resultant of the autonomous electric vehicles spread range integrating departure station electric multi-modal car autonomy surface coverage 1003, intermediary station electric multi-modal car spreading range 1004, and the terminal station electric multi-modal car spreading range 1005. The electric vehicle spread range is done using the local roads 1006 in the limits of driver's residence or vehicle autonomy.

FIG. 11 shows another embodiment of the invention related to the electronic control system 1100 equipping the vehicle, controlling one or more of the following functions:

Dynamic Functions:
a) tilt forward and acceleration 1101 is a special function presented only to the vehicles having two freedom degrees in the structure. The tilting forward is a fancy function mainly increasing the driver's comfort and equalize the weight among wheels. For rear traction vehicles that brings no advantage, reducing the maximum possible acceleration at the wheel skidding limit but favors the integral traction vehicles.
b) tilt backwards and slow-down 1102 is also a function present in luxury systems meant to male the driver to feel less forward acceleration give a favorable impact angle during accidents. It also activates the regime of generators in the driving electric motors recovering the power. When the break down acceleration request is high over the capabilities of the electric motors, the mechanical breaking system is activated and the adhesion control system assists the mechanical breaks.

These functions are also dangerous for the vehicle if activated statically on express control it may require powerful actuators to perform the movement. In dynamic conditions first acted is the tilt actuator then the dynamic control function adjusting the acceleration to equalize the forces and put the resultant force in the middle of the base, and correct the position before the dynamic limitation occurs and requires more power in actuator. The forward tilt has to consider frontal wind component in the upper acceleration dynamic limits.

An adaptive system detecting the limits of possible acceleration as driven by the wheel's adhesion have also to be set in place and limit the tilt at the right value. It limits the forces in the driver to undetectable variation in gravitational equivalent force in the 50% range by maximum ½ g.
c) Tilt laterally and turning radius and speed 1103 equalizing the centripetal force, that is a function of speed and turning radius. In normal operation conditions a smooth turn in the steering wheel will translate in a tilt command and the wheels will follow the tilt as result of calculator. If the command to turn overpasses the capability to tilt the wheels will follow the turn command. At cheep versions the stirring wheel will act directly on front wheels while the tilt actuator will follow trying to get the right angle.
d) Impact and rolling modulus 1104 is controlling the pilot protection, acting the inflatable bags and the supplementary elastic fixtures in order to minimize the cockpit's accelerations. This modulus integrates the communication functions and driver assistance making automatically the necessary calls and recording the pre-impact and impact parameters.
e) Aerodynamics of the roof and carts module 1105 is measuring the force in the supports and smoothly corrects the position of the roof in order to have equal forces and no lift with minimal drug.
f) Power management and harvesting modulus 1107 is integrated in power control system, but as distinct circuit it refers to adjusting the battery loading in parallel with consumption keeping the solar arrays matched in the maximum power impedance value. It some evolved version an intermediary buffer battery may be added to allow higher fluctuations and power demands in electric motors.
g) Wind and drag/lift forces modulus 1106 is applied to cart panels. Being very light structure the cart has increased aerodynamic sensitivity following a tendency to fly jump or wiggle. Special wing profiles included in the lateral and rear protection will actuate making the flow laminar and keeping a constant weight with minimal vibrations. By this algorithm the driving improves in various wind conditions.
h) Cockpit air conditioning 11011 is a feature needed in winter and hot summer—the cooling/heating system is composed of a compressor based heat pump using electricity produced by the solar panel. An electronic system stops the heat pump when cockpit is open or the temperature differences turns in the acceptable tolerance limits. Secondary water-cooling cockpit systems may be used to save electricity where water is available.

Static Functions
a) Rolling surface horizontality modulus 1109 is a feature integrated in the lateral and frontal tilt systems making the car operate in highly tilt roads.
b) Energy harvesting modulus 1108 is a function active when the vehicle is parked loading its batteries. It balances the energy possible to harvest from sun with the grid charging capabilities integrating the harvesting predictions with the driver's demand. Other auxiliary power systems are integrated as grid charge.
c) Safety and security modulus is integrated in other functions group 11012 as a function simply detecting intrusions, vandalism or harsh weather manifested as high wind, hail rain when it acts protecting itself.

i) Power management functions are integrated in modulus 1107
a) Battery charging from solar roof or from grid is treated by modulus 1106 it has the role to maximize when possible the harvested solar energy, but to have the batteries loaded at the desired time, set by the driver and agreed by the system.
b) Power backup for house system at special order 11010 is a special function to use the car energy for residential emergency backup. The delivered power will be in a battery compatible voltage in agreement with house system that has to limit its consumption to the needed functions and disconnect from the grid.
c) Battery banks status control is a function integrated in both safety systems 1112 and power management 1107 showing the status of batteries.
j) Other functions is a complex luxury module 1112 integrating a series of modern functions as:
a) Navigation that is done by GPS on satellite and cellular phone grid, inertial and acceleration control, speed control, and complex energy optimizer.
b) Driving assistance that makes mainly speed control, accelerations, skid control and automatic driving functions with obstacle detection.
c) Driver assistance refers to air conditioning system, air quality driver vital functions monitoring and alerts, route control.
k) multimodal functions are also integrated in other functions modulus 1112 and refers to supplementary electronic assistance for multimodal transportation referring at:
a) Loading-unloading procedures launched by external remote communication. All systems on vehicle are positioned in the optimal position as air conditioning shut down or paused, the wheels blocked the aerodynamic adjustments off, etc.
b) Transport security system, controls the accelerations inside and disconnects the power in case of hazards.
c) Charts assistance, represents a map transport function, signalizing the intent of the driver to get a multimodal ride, and scheduling as function of its distance in terrain and the capability or reaching the terminal. This is a wireless internet function on GPS or cell phone system.
d) Other computer functions and laptop specific integrated functions with voice activation and control may be used during automatic navigation.
e) The computer system has to have a distributed structure with universal command from cockpit and from external sources with smooth control transfer assured by standardization

FIG. 12A Shows the multi-modal electric vehicle floating on water 1200. The power trains 1202 are under water surface having negative buoyancy using the wheels equipped with fins 1201 for propulsion and creating water jets 1215.

The connection system 1203 integrates the cockpit 1210 hydrodynamic designed with a supplementary floating structure 1270 giving an enhanced stability by placing the meta-center above the center of mass.

The sun harvesting modules 1206 are above the water surface using the polls 1205 with adjustable height.
FIG. 12B present another embodiments of the present invention making a synthesis of potential multi-modal propulsion means.

The vehicle is composed from the same basic modules the cockpit 1240 made in a stealth design or eggshell design 1234. The poles 1235 and the harvesting panels 1236.

The propulsion modules 1232 having the extremities terminated by a headlight, position and direction signal lights 1237. The wheels 1231 have tires and a finned structure 1241 coated in hydrophobic material as PTFE for water, mud or snow propulsion. The forehead 1232 is acting as a cutting blade limiting the size of the material underneath, mainly good for snow.

The connection structure 1233 has multiple roles; it may hold and integrate the floating structure 1230 and hold the rail traction adaptors 1270. Instead of traction adaptor in 1270 device may be placed the Electro-Magnetic wire pathfinder device used in automatic pilot navigation.

For very tilted roads requiring high power motors this may be done by street integrated cable propulsion 1260 that draws the vehicle by cable 1261.

The propulsion modules 1232 have multi-modal adaptors 1244 used to support the entire vehicle structure in a specialized crane adaptor 1253, having 4 cables or bars 1254 that are connecting to the multi-modal adaptors 1244. The cable 1252 in a rail crane to be loaded in a multimodal transport vehicle—see FIG. 9—may hang the structure or may be used in a cable transport system made of the support cable 1250 and the pulley wheel 1251. The same system may be used in a monorail system.

FIG. 13 shows a magnetic levitation propulsion system that may be used to carry the cockpit only or the entire structure. It is made of the profiled rail 1330, the magnetic propulsion modules 1331 integrated in the structure 1332. The structure has the power harvesting units trolleys 1333 at lateral connections or rails.

FIGS. 14A and B shows a foldable connection structure compaction for multi-modal transport or storage.

FIG. 14A shows an egg shaped module without flotation system compacted in a 2-3 ft width and 3-5 ft height ready to be stored or loaded in a multi-modal container.

It is further possible to lift the wheels 1401 to gain the ground cart space but it is an option. The propulsion modules 1403 are coming one tear the other at few inch apart by folding the connection module 1404 keeping the cockpit on center and maintaining the displacement capability. The front and rear modules 1402 having the lights may also fold up taking the wheels off the ground.

The cockpit 1410 is touching the modules 1403 and but leaves clear access to the multi-modal adaptors 1404. The pillars 1405 holding the solar harvesting panels are also folding down making the solar panel 1406 fold and touch the upper side of the cockpit.

FIG. 14B shows a stealth shaped cockpit 1410 containing a floating module 1440 compacted. It also contains a rail training system 1431 attached in center. To be loaded in the multi-modal container it has to be connected by the crane adapter 1423 having hooks on cables 1422. The entire system goes into a rail crane 1430 by the lifting cable 1424.

FIG. 15 shows a longitudinal section through the modular solar electric vehicle system.

The vehicle contains two battery modules 1503 that have to be as equal as possible. When connected through the connection module the battery power regulators 1556 adjust the common power level of the vehicle. This power will be delivered to the cockpit and all the systems including the wheels 1501 motors' regulators 1551.

The battery module 1503 is an autoportant/self-sustaining structure loaded with batteries. 1555. The type and parameters of the batteries are further subject of optimization and customization. The batteries have included a smart diagnostic, power management and charging system 1558, transferring power from grid, solar system or spare thermo-mechanical generators, even from a driver power by using a set of pedals generator/dynamo inside.

The wheel module 1502 having the wheel 1501, suspension, direction and electric motor for propulsion is connected in the fast locking fixture 1551.

The connection system/module 1504 is standardized and it may connect a large variety of propulsion trains. It has the tilting devices included in the structure. It also holds a protection grid front and rear formed with laminar aerofoils profiled grill 1514.

This grill has only collision role being mounted on the central axe 1515. Under the battery module there are a set of support wheels, grips 1554 to aid easy coupling.

The multi-modal adaptors 1559 are located on the propulsion trains, and they also contain the solar panel poles 1505, that hold the solar array 1506. The solar panels may be flat and producer independent 1506, or may be profiled 1516, to minimize the aerodynamic resistance.

The cockpit 1510 is fixed in a standardized 3 points (or more in special cases) lockable fixture 1530 present underneath at the central axe 1515 of the connection system 1504, and above the cockpit. This feature allows the fast coupling of the cockpit at various propulsion trains.

The cockpit is conceived insulated from the power trains by a set of suspension and shock absorbers. The tilting will minimize the acceleration variation vector in the passenger bodies giving an air gliding feeling.

The safety reliability and comfort are enforced from the concept. The cockpit 1510 has an aerodynamic or stealth outer shell that is connected up or down to propulsion or transport trains in the standardized fast locking fixtures 1530. Inside the shell 1510 near the external fixtures 1530 a set of elastic vibration absorbing components 1521 are fixing the pilot/driver cage 1520 into a system designed to hold a uniform variation of acceleration during shocks or accidental impacts. During an impact the driver's cage 1520 is slightly sliding on the glides 1522 proportional with the acceleration, turning to minimize the uncomfortable accelerations in the driver's body.

The front of the cockpit contains a shock energy absorbing material 1523, which may also incorporate life support functions as ventilation and air purification. The cockpit's computing system with the necessary batteries 1528 are placed in a safe position being protected for electric shocks and other aggressions. The end side of the cockpit is aerodynamically terminated having an inflatable pillow 1529 for aerodynamic and back impact adjustments. The airflow 1511 is maintained as laminar as possible to assure the minimal aerodynamic resistance.

The seat 1526 and the steering and controls 1527 are adjustable in order to best accommodate a 7 ft male 1524 or a 4 ft female or child 1525 head upper level.

FIG. 16 also called options list or menu presents various configurations allowed by the advanced modularity.

FIG. 16A shows the battery propulsion train options. These refer to the propulsion wheels modules 1601 where the wheel type, radius, tire, and the wheel fin may be selected. The power of the wheel and the stirring 1603 may be also selected. It is possible to choose full propulsion and 4 wheels stirring. Chains of propulsion wheels may also be possible creating a 6,8 wheeler.

The battery tank may be also selected 1602 customizing the battery capacity, type, voltage and other parameters. The connection system distance L may be also selected 1604 allowing a diversity of connection modules and adaptors.

FIG. 16B is referring to the connection module customization. The connection length L 1604 have to be decided and the cockpit connection type. Than the tilt freedom degrees 1623 may be selected from 0, 1, and 2 meaning rigid structure, lateral tilt and longitudinal tilt. The connection module may have a floating structure 1625 and a folding structure 1624. On the bottom 1622 it may have a power module as rail, or cable traction or an electromagnetic cable follower, or street power loading trolley.

FIG. 16C shows some special options may be taken for amphibious and underwater applications. The propulsion module may have a hydro, mud, snow fin profiled wheel 1633, may have an air cushion to glide on mud and shallow waters 1632 and for underwater it have to have attached the vertical and lateral displacement systems, 1634 and possible a remote arm. For all of these the cockpit and its computer has to be compatible.

FIG. 16D is showing the potential selections for the cockpit and solar panels. The cabin may have 1610 various types housing from 1 seat up to several seats—say 5, by adding an extension module 1611, between the cockpit and the termination body 1612 that may hold the pressure cushion shape adaptor, luggage trunk, and rear impact protection systems. The safety design comes from inclusion of a rigid passenger cage in the cockpit shell, with the role of extending the impact deceleration range and dimming the deceleration to acceptable limits.

The selection for the solar power harvesting system 1640 is complex, may decide between the flat or shaped panels, the efficiency, size, folding, manufacturer, buffer battery.

FIG. 17 shows how the cockpit is mounted on a power train.

The cockpit 1710 having the door 1711 has to be handled in such a manner as to have the emergency door access operational all the time. The cockpit has a set of handlers 1721 from where two men may lift and set on the train, being a light 100-200 lb structure.

It has 3-wheeled foldable lockable legs 1722 for ease of movement and can be put on the power train 1703 by guiding on the locker axis 1715 until the lockers 1720 get into position and click on locking the system. The power train on it's wheels 1701 may be driven into the cockpit to make the coupling. An emergency unlock mechanism may be available from the cockpit to safely eject the cockpit.

FIG. 18 Shows the Cost and Mileage as function of transport means made for real transport means using available statistical data.

The single passenger equivalent transport efficiency chart 1800 is made using Internet available statistical data showing the efficiency of various transportation vehicles. On the left ordinate is given the cost per passenger per mile in (cents/mille) or [USD/100 miles], 1801, and on the right ordinate is given the specific mileage or energetic equivalent consumption in mpg 1802 being different from the left ordinate by the cost of a gallon, for various types of transportation 1803, generically called “modes”.

The legend 1804 shows the difference between the two inverse proportional functions.

The data have been sorted after the cost range for various transport systems 1805.

The thick arrow in the right is showing that the large bars are read on Cost logarithmic axis 1806, and refers to all cost bars 1807.

The thin arrow showing that the mileage narrow bar is read on the mpg axes 1808 and refers to all Mileage narrow bars 1809. The importance of this figure consists in showing the real values and their distribution for various very particular systems. This is an indication of what performances a vehicle type may reach shown by the ellipsoids 1805. It also shows the basis of calculation for this invention.

FIG. 19 shows the performance of the transport mode with respect to mileage and speed as an important classification criterion in a double logarithmic chart.

The performance distribution of the transportation means 1900 is represented as function of transportation speed 1901 and mileage 1902 as important input data in invention development, showing the reality and the room for performance. The Diamond point 1904 is showing the position of the particular statistics data that appears in the previous chart at mileage and cost for equivalent person transportation with an average weight of 100 kg. From this data the domain of performance of the invention has determined as having the cockpit weighting another 100 kg, doubling the passenger mass, therefore reducing the mileage by half.

The ellipsoid showing the domain 1905 represents the calculated possible performance of the multi-modal device, while the line 1906 shows the correlation speed-mileage for the respective transportation mode. The total transportation being a linear combination of the 10 identified in the chart by ellipsoids, transportation modes.

FIG. 20 shows the main elements of air platforms propulsion attached system covering the modes A and H in FIG. 19.

The cockpit 2010 with the passenger inside is the only part of the assembly that is transferred and connected to various propulsion systems using the multi-modal lockable fixture 2020.

To fly the cockpit in the future virtual air high-ways a flying UAV wing 2050 may be used that has the propulsion made by gas turbines 2051, the only hard to replace propulsion, but being non-ecologic.

Another type of flying mode is Helicopter like, and that may be achieved by connecting the cockpit 2010 to a helicopter skeleton structure 2060, with turbo-fans propulsion 2062 driven by a motor-generator 2063 powered by a liquid fuel tank. Power levels above 200 kWe are required and direct internal combustion engine-gear combinations are competitive approaches to this application. To get this system functional a very delicate combination between the local cockpit computer and a central navigation system on ground have to be achieved.

What is claimed is:

1. A multi-feature multi-modal system of transportation using a combination of vehicles made of:
A multi-modal electric light vehicle with multi-modal adaptors
A specialized carrier container or a combination of such with the capability of loading many multi-modal electric vehicles and their passengers compatible with Road or Rail (ROR) transportation system
A plurality of propulsion system that can be attached to the multi-modal vehicle or parts of it.

2. A multi-modal electric vehicle according to claim 1 made off functional modules assembled after the need:
A plurality of driver and passenger cabin said cockpit with multi-modal adaptors
A plurality of propulsion units
Two wheels power trains with multi-modal transport adaptors
A customized flexible connecting system
An integrated functions, distributed electronic control system
A floating unit
A solar harvesting roof
A plurality of solar harvesting carts
Protective systems

3. A multi-modal adapted ROR (Rail or Road) standard container or a combination of such according to claim 1 made off:
A partition or more for loading the multimodal electric vehicles
A partition or more for loading the drivers
Specific multi-modal compatible devices as ramp/stairs doors, extendable crane, lifting floors

4. A multi-modal electric vehicle according to claim 2 build by using two-wheeler light structures as scooter, bicycle, motorcycle connected by a bridge directly or with hinges with parallel axes to elastic equal effective length shaped bridges stabilized by verticality control system.

5. A multi-modal electric vehicle according to claim 2 build by using two-wheeler light structures as scooter, bicycle, motorcycle, equipped with electric motors and batteries forming a power train cased in aerodynamic structure equipped with stair features and multi-modal transportation features as hooks and wheel blockers and floor supports.

6. A multimodal electric vehicle according to claim 2 and 5 build by using two-wheeler power trains holding poles for the solar roof

7. A multimodal electric vehicle according to claim 2 and 5 build by using two-wheeler light structures as scooter, bicycle, motorcycle, having the cockpit or a plurality of cockpits connected by a hinged parallelogram structure on the transversal axes staying parallel with the power train height axis.

8. A multi-modal electric vehicle according to claim 2 having the possibility to trail several solar harvesting carts, to have day light autonomy.

9. A multi-modal electric vehicle according to claim 2 and 8 with the dimensions trimmed to become compatible with ROR containers adapted for multi-modal transportation.

10. A multi-modal adapted ROR container or set of containers according to claim 3 adapted to load/unload in open terrain using doors/ramp-stair structures and sliding adjustable crane and parallelogram jack floors with multimodal electric car compatible structures.

11. A electric vehicle according to claim 2 made of the following modules: two power trains, cockpit, solar roof joined by a two freedom degrees structure that can controllably tilt in two directions lateral and forward-backward to compensate for dynamic forces, or rolling surface.

12. A electronic control system according claim 2 equipping the vehicle, controlling the dynamic tilt and several other functions of the power systems.

13. A multi-modal electric vehicle according to claim 2 having the cockpit fixed in the center of the transversal axes or hanged by an elastic fixture from the roof to have a slight oscillation back-forth to compensate for the longitudinal acceleration effects.

14. A multi-modal electric vehicle according to claim 2 having the solar harvesting roof made from a adjustable height structure and for an aerodynamics control of its longitudinal tilt

15. A multi-modal electric vehicle according to claim 2 having an advanced protection collision system made of elasto-plastic materials, to absorb the impact energy, retractable for packing in container.

16. A multi-modal electric vehicle according to claim 2, carrying solar carts having lateral protection for animal collision with good lateral aerodynamic coefficient.

17. A multi-modal electric vehicle according to claim 2 having a modular propulsion system made of wheels unit containing the motor and steering wheel, electric drivers and feedback devices, equipped with light and signaling systems connected to an interchangeable battery bank

18. A multi-modal electric vehicle according to claim 2 having a cockpit with standardized top and bottom adaptors to specialized propulsion systems as rail, mono-rail, air water

19. A multi-feature multi-modal system of transportation using a combination of vehicles according to claim 1 oriented on transportation of the cockpit with passenger mainly by connecting the cockpit to a large range of direct grid powered propulsion system to minimize the need of battery capacity and maximize by central computing system the battery utilization in economic regimes.

20. A multi-modal electric vehicle used to backup the house power by connecting the car's batteries to a specialized house power generator that charges the batteries when the grid is on or powers the house life support systems mainly during blackouts.
